(19) United States
(12) Patent Application Publication
(10) Pub. No.: US 2026/0164069 A1
(43) Pub. Date: Jun. 11, 2026

(54) SYSTEMS AND METHODS FOR DYNAMIC CROSS-PROFILE MANAGEMENT AND OFFLINE MEDIA CACHING IN STREAMING SERVICES

(71) Applicant: Adeia Guides Inc., San Jose, CA (US)

(72) Inventors: Charles Dasher, Lawrenceville, GA (US); Jean-Yves Couleaud, Mission Viejo, CA (US); Reda Harb, Saint Petersburg, FL (US)

(21) Appl. No.: 18/971,364

(22) Filed: Dec. 6, 2024

(51) Int. Cl. H04N 21/231; H04L 67/306; H04N 21/254; H04N 21/431; H04N 21/4385

(52) U.S. Cl. CPC H04N 21/23106; H04L 67/306; H04N 21/2541; H04N 21/431; H04N 21/43853

(57) ABSTRACT

Systems and methods are described herein for intra-account content caching and distribution, wherein content is dynamically managed. The disclosed techniques may generate specific configuration data for each device associated with a streaming service account that governs content retrieval, playback, and transfer. The disclosed techniques may additionally dynamically allocate storage and manage content transfer based on factors such as device proximity, available storage, and network conditions.

### BACKGROUND

This disclosure is related to systems and methods for managing media content across multiple devices and user profiles within a shared streaming account. In particular, the disclosure relates, in part, to dynamic storage allocation and content transfer across multiple devices.

### SUMMARY

In one approach, systems have enabled content to be downloaded for offline viewing to the specific device on which it was originally stored. For example, such capability enhances systems'performance by providing the ability to access content uninterrupted even when the designated devices are disconnected from the internet or have limited connectivity, such as during flights, on cruise ships, or in remote areas.

In some approaches, streaming services have the capability to synchronize user profiles, watch histories, and preferences across multiple devices within a single user account. For instance, if a device is logged into using the credentials of a streaming service account on a laptop and has begun streaming a movie, a mobile device is able to use the same credentials to log into the streaming service and finish streaming the movie where the stream was paused on the laptop. However, in such approaches, if the user-interface input to download the movie to view for offline consumption was received via the laptop, the movie is downloaded to that specific device, for example to the laptop. Consequently, the mobile device is unable to leverage the downloaded content on a second device, such as the laptop and is forced to re-initiate the stream from the server which requires expending additional bandwidth and causes extra computing strain on the streaming server.

In other approaches, streaming services provide features such as “Smart Downloads”, used for managing and optimizing content storage on devices. Such feature may enable automatic downloads of content such as episodes, movies, or other media based on user preferences and viewing habits. For instance, a streaming service may download (e.g., as a push without user's explicit selection) the next episode in a series a user has been watching when connected to the internet, and delete older, watched episodes to manage storage space on the device. However, the “Smart Download” feature remains device specific. In other words, this feature lacks the ability of cross device synchronization, therefore, limiting the ability to access media seamlessly across multiple devices.

Additionally, devices have storage limitations and bandwidth constraints that can prevent all desired content from being downloaded. For example, if a device located in an airport, receives a user interface input requesting a download of a movie, the entire movie may be unable to be downloaded due to the substantial bandwidth demand required for downloading the movie, and the limited bandwidth associated with the network at the airport.

Consequently, downloaded content is only accessible on the device where it was originally downloaded, requiring direct access to any device in which downloaded content is stored. If content is desired to be accessed across multiple devices, the content must be manually downloaded to each device. Downloading the same content to multiple devices significantly increases demand on the server which leads to expending additional bandwidth, leading to slow download speeds or even outages for devices attempting to access the content. Additionally, each device downloading the same content means that the server must manage and transmit for storage redundant copies of the content, which leads to significant bandwidth requirements increase the server.

Accordingly, to address such problems, example systems and methods are provided herein, wherein the system distributes and manages downloaded content across multiple devices (e.g., associated with a single user account). In some embodiments, the system provides configuration data designating one or more devices associated with a user account as primary and secondary, cache devices for content storage as described herein. In some embodiments the system comprises a primary device, at least one secondary device, and at least one server. Devices of the system may execute a content distribution management (“CD”) application. In some embodiments, for example, the CD application may be executed at least in part on the primary device, the at least one secondary device, and/or at one or more remote servers. In some embodiments, the CD application is executed when a processing circuitry executes instructions stored in a non-transitory memory that when executed causes performance of steps describe above and below in this disclosure.

In some embodiments, the primary device, as part of executing the application, transmits to at least one server of a plurality of servers associated with a streaming service, associated with a user account, a request for storing a content item for offline consumption. In some embodiments, the primary device receives from the at least one server of the plurality of servers a first configuration data used to configure the primary device with a permission to access the content item from a secondary, cache device associated with the user account.

In some embodiments, the at least one server of the plurality of servers is configured to transmit, to the secondary device associated with the user account, second configuration data used to configure the secondary device with a permission to store the content item and transmit the stored content item to the primary device. In some embodiments, the at least one server of the plurality of servers is configured to transmit for storage at the secondary device at least a portion of the content item.

In some embodiments, based on a user interface input to play the content item at the primary device, the primary device accesses, using the first configuration data, the at least a portion of the content item from the storage of the secondary device, wherein the secondary device transmits the at least a portion of the content item using the second configuration data.

The example systems and methods described herein help to overcome the deficiencies in existing solutions. Such aspects enable the system to provide a profile-based caching and transfer system with configuration data specific to each device enabling the content to be accessible on the appropriate device without requiring manual download on each device. The method described herein for the CD system managing downloads across devices associated with the same streaming account, ensures that the same content is only downloaded once, eliminating the need for repeated downloads, and shared across the devices, through peer-to-peer technologies or over a local area network (LAN). Once the content is downloaded to the devices associated with within the same streaming account, the system can use, for example, local network transfers (e.g., Wi-Fi Direct, devices connected to the same access point (AP), etc.), to distribute the content to other devices associated with the streaming service account without the need to re-download it over the internet, reducing demand on the server. Further, using local network transfers reduces latency and improve overall transfer performance. The method descried herein for the CD system to minimize the storage burden on each of the devices associated with the same streaming account, enhances each of the device's performance allowing the devices to, for example, cache files temporarily and/or perform tasks in the background. The method descried herein for the CD system to manage content across devices also automates the download process, ensuring that the devices are updated or have access to the content based on the device specific configuration data, without the need for the content to be manually managed at each device. The method described herein for the CD system to manage the content across the devices also enforces consistent digital rights management across all of the devices associated with a streaming service account, ensuring that files are securely stored at each device, reducing the risk of unauthorized playback.

In some embodiments, the first configuration data further comprises a permission to store a portion of the content item different from the at least a portion of the content item stored at the secondary device. For example, the primary device, based on the first configuration data, is configured to store the initial portions of the content item, such as a thumbnail, a first N number of bytes, or the first N number of segments of the content item. In some embodiments, the at least one server of the plurality of servers is configured to transmit for storage at the primary device, the portion of the content item different from the at least a portion of the content item stored at the secondary device. In some embodiments, based on the user interface input to play the content item at the primary device, providing for output at the primary device, the portion of the content item stored at the primary device different from the at least a portion of the content item stored at the secondary device. For example, in response to receiving an input to play the content item at the primary device, the primary device, may output the stored initial segments of the content item allowing for immediate playback, while simultaneously establishing a connection with the secondary device and/or retrieving additional segments from the storage of the secondary device.

In some embodiments, the user account comprises a number of profiles (e.g., a first user profile and a second user profile). In some embodiments, for example, a first user profile is associated with the primary device and a second user profile is associated with the secondary device. In some embodiments, the primary device receives a user interface input for selecting the second user profile associated with the secondary device to store the content item. In some embodiments, the at least one server of the plurality of servers transmits a notification to the secondary device prompting approval to store the requested content item at the secondary device.

In some embodiments, the at least one server of the plurality of servers transmits the at least a portion of the content item in encrypted format. In some embodiments, the at least one server of the plurality of servers provides the primary device with a key for decryption of the at least a portion of the content item in encrypted format. In some embodiments, the secondary device, based on the second configuration data comprises restricting the secondary device from storing the key for decryption in non-transitory memory (e.g., the key may only be stored in transitory memory for the purpose of being forwarded to the primary device after which the key is deleted) of the at least a portion of the content item in encrypted format. In embodiments, the secondary device, based on the second configuration data comprises a key for decryption of the content item in encrypted format based on a request from the secondary device to play the content item at the secondary device. In some embodiments, the secondary device, based on the second configuration data is configured to store the key (e.g. in transitory memory). In some embodiments, the second configuration data configures the secondary device with restrictions, such as restricting the use of the key only for transfer to the primary device upon a request from the primary device to access the content. In some embodiments, the secondary device is configured to be unable to use the stored key to decrypt the at least a portion of the content item stored at the secondary device in encrypted format (e.g., because the key is intended only for transfer). In some embodiments, the secondary devices may receive updated configuration that allows for usage of the key for decryption (e.g., based on secondary devices becoming designated as a new primary devices).

In some embodiments, wherein the primary device accesses the content item from the storage of the secondary device, the primary device removes, from the secondary device based on the second configuration data, the content item from the storage of the secondary device. For example, once the transfer of the content item from the secondary device to the primary device is completed, the content item is removed from the secondary device, based on the second configuration data, freeing up storage space on the secondary device. In some embodiments, the primary device, in response to receiving portions of the content item that were requested by the primary device from the secondary device, transmits an acknowledgement to the secondary device. In some embodiments, in response to receiving, at the secondary device, the acknowledgement of receiving the portions of the content item from the primary device, the primary device removes from the storage of the secondary device based on the second configuration data the acknowledged portions of the content item. In some embodiments, the primary device transmits an acknowledgement of the received content item after all portions of the content item have been received at the primary device. In some embodiments, in response to receiving the acknowledgement of receiving all portions of the content item at the primary device, the primary device removes from the storage of the secondary device based on the second configuration data all portions of the content item.

In some embodiments, the second configuration data comprises a restriction to access the at least a portion of the stored content from the storage of the secondary device. In some embodiments, transmitting for storage at the secondary device at least a portion of the content item further comprises based on a user interface input to play the content item at the secondary device, denying access, using the second configuration data, to the at least a portion of the content item from the storage of the secondary device.

In some embodiments, the first configuration data or the second configuration data further comprises a time restriction for permitting the transmission of the stored at least a portion of the content item from the secondary device to the primary device. For example, in some embodiments, based on the user interface input to play the content item at the primary device, determining, based on the second configuration data, whether the user interface input to play the content item at the primary device was received within the time restriction for permitting the transmission of the at least a portion of the content item from the storage of the secondary device to the primary device.

In some embodiments, the first configuration data further comprises digital rights management information. In some embodiments, based on the user interface input to play the content item at the primary device, determining, based on the digital rights management information in the first configuration data, whether the primary device has access rights to the at least a portion of the content item from the storage of the secondary device. In some embodiments, based at least in part on determining the primary device has access rights to the at least a portion of the content item from the storage of the secondary device, accessing, using the first configuration data, at least a portion of the content item from the storage of the secondary device, wherein the secondary device transmits the content item based on the second configuration data.

In some embodiments, transmitting to at least one server of the plurality of servers associated with the streaming service, by the primary device associated with the user account, the request for storing the content item for offline consumption. In some embodiments, the at least one server of the plurality of servers determines, an available storage capacity at the primary device and an available storage capacity at the secondary device. In some embodiments, the at least one server of the plurality of servers selects, based on the available storage capacity of the primary device and/or device type (e.g., device make/model) and the available storage capacity of the secondary device, a particular version of the content item for storing for offline consumption. For example, a download component or service associated with the media server (e.g., OTT service) may select a HD version of the content item instead of an UHD or 4K version. Each version of the media content item maybe associated with a bit rate/resolution pair. Additionally, the selection and download of the particular version of the content item maybe performed by selecting at least some media segments of the content item that are associated with the chosen bitrate/resolution.

In some embodiments, the at least one server of the plurality of servers is configured to transmit the first configuration data or the second configuration data to the primary device or the secondary device comprising a playback manifest file associated with the content item wherein the playback manifest file comprises URIs of portions of the content item.

In some embodiments, the at least one server of the plurality of servers transmits for storage at the secondary device the at least a portion of the content item. In some embodiments, the at least one server of the plurality of servers determines, an available storage capacity at the primary device. In some embodiments, the at least one server of the plurality of servers, in response to determining the primary device has insufficient storage capacity to store all portions of the content item, determines, an available storage capacity at the secondary device. In some embodiments, in response to determining the secondary device has available storage capacity to store at least a portion of the content item, the at least one server of the plurality of servers transmits for storage at the secondary device, the at least a portion of the content item.

### BRIEF DESCRIPTION OF DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A and 1B is a schematic example of dynamically managing content across multiple devices and profiles associated with a shared streaming account based on configuration data and cache device selection, in accordance with some embodiments of this disclosure.

FIG. 2 is an illustrative example of a configuration data file, in accordance with some embodiments of this disclosure.

FIG. 3 shows an illustrative sequence diagram for dynamically managing content across multiple devices and profiles associated with a shared streaming account based on configuration data and cache device selection, in accordance with some embodiments of this disclosure.

FIG. 4 shows an illustrative sequence diagram for dynamic device role reassignment, in accordance with some embodiments of this disclosure.

FIG. 5 shows an illustrative sequence diagram for managing and preparing content for profiles associated with the same streaming service account, in accordance with some embodiments of this disclosure.

FIG. 6 shows an illustrative sequence diagram for profile-based content transfer and associated data between profiles and their respective devices associated with a shared streaming account, in accordance with some embodiments of this disclosure.

FIG. 7 is an illustrative example of proactively caching content to specific devices based on learned behavior, in accordance with some embodiments of this disclosure.

FIG. 8 shows illustrative devices and systems for dynamically managing content across multiple devices and profiles associated with a shared streaming account based on configuration data and cache device selection, in accordance with some embodiments of this disclosure.

FIG. 9 shows illustrative devices and systems for dynamically managing content across multiple devices and profiles associated with a shared streaming account based on configuration data and cache device selection, in accordance with some embodiments of this disclosure.

FIG. 10 is an illustrative example of a graphical interface to manage content storage and transfer across multiple devices and profiles associated with a shared streaming account, in accordance with some embodiments of this disclosure.

FIG. 11 is an illustrative example of graphical interface to manage content storage and transfer across multiple devices and profiles associated with a shared streaming account, in accordance with some embodiments of this disclosure.

FIG. 12 is an illustrative example of graphical interface to manage content storage and transfer across multiple devices and profiles associated with a shared streaming account, in accordance with some embodiments of this disclosure.

FIG. 13 is a flowchart of a detailed illustrative process for dynamically managing content across multiple devices and profiles associated with a shared streaming account, in accordance with some embodiments of this disclosure.

### DETAILED DESCRIPTION

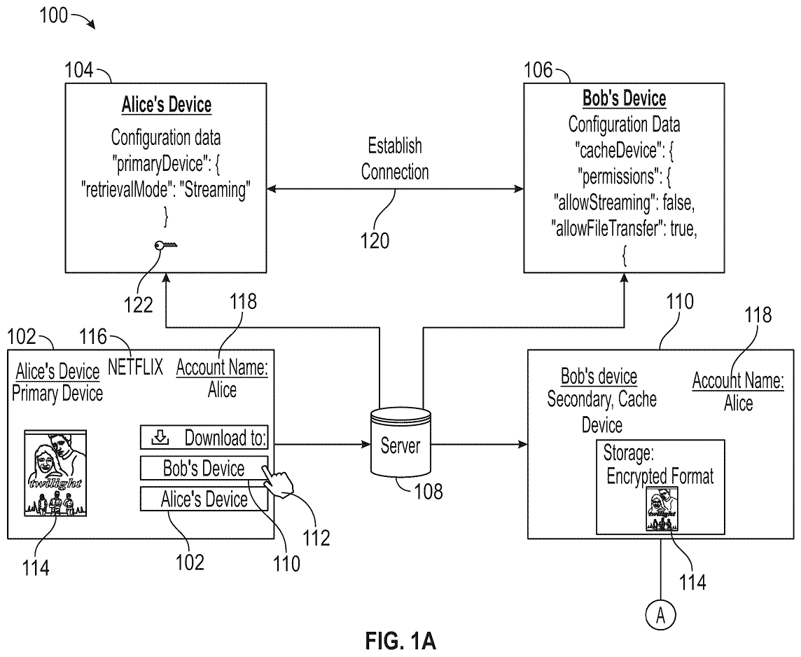

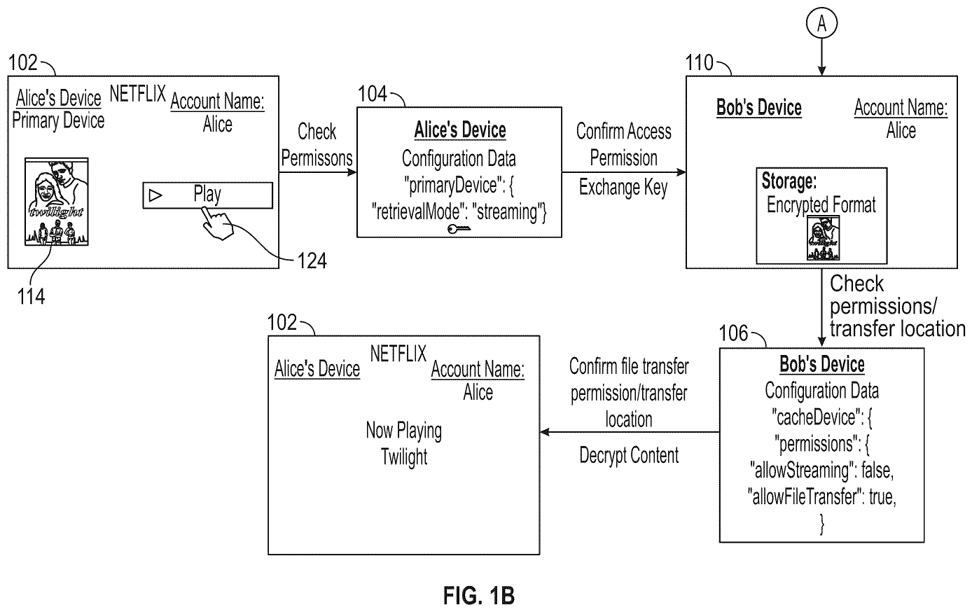

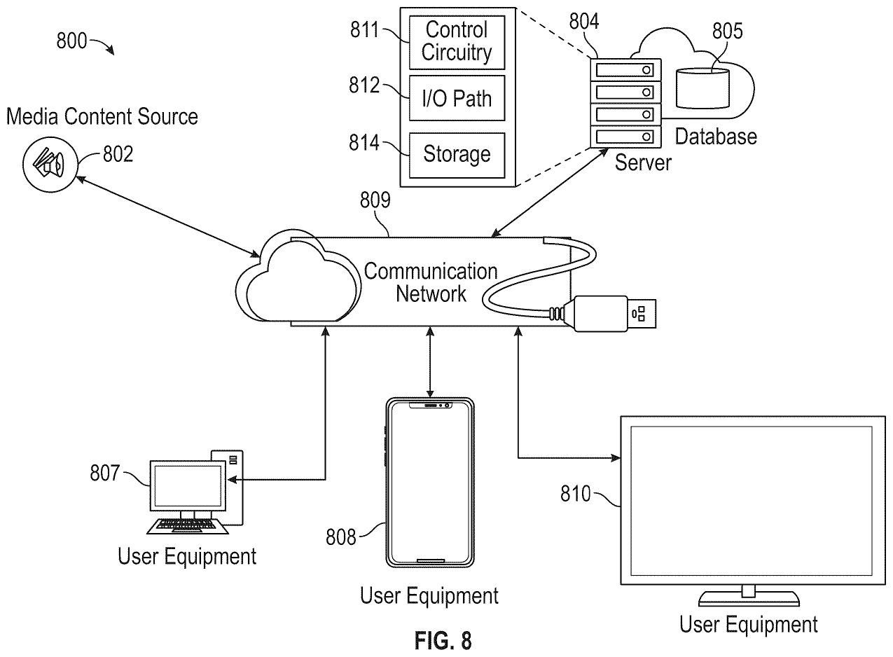

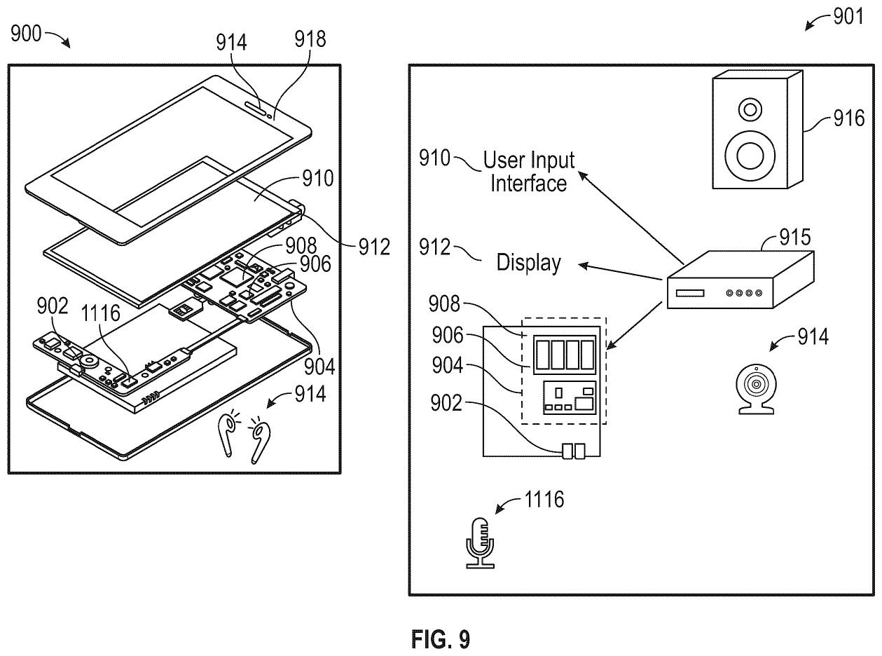

FIGS. 1A and 1B shows an illustrative system 100 for dynamically managing content across multiple devices and profiles associated with a shared streaming account based on configuration data and cache device selection. In some embodiments a (content system) content distribution system 100 (referred to herein as “the CD system”) comprises or corresponds to a primary device 102, at least one secondary device 110, and at least one server 108 (e.g., a streaming service server), or any other suitable platform, or any combination thereof. In some embodiments, the CD system comprises or corresponds to multiple devices (e.g., five, fifteen, twenty, etc.) and at least one server 108 (e.g., a streaming service server). In some embodiments, all devices, for example, a primary device 102 and at least one secondary, cache device 110 within the CD system, are logged into using the credentials of a single streaming account wherein the content is managed across the multiple devices (referred to herein as “the shared storage pool”). The system may comprise a CD application, that is executed when a processing circuitry executes instructions stored in a non-transitory memory that when executed causes performance of steps described above and below in this disclosure. The CD application may be executed at least in part on the primary device, the at least one secondary device, and/or at one more remote servers (e.g., server 804 of FIG. 8 and/or media content source 902 of FIG. 9). The CD system may be distributed across any of one or more other suitable computing devices, in communication over any suitable number and/or types of networks (e.g., the Internet). The CD application may be configured to perform the functionalities (or any suitable portion of the functionalities) described herein. In some embodiments, the CD application and/or the CD system is a stand-alone application, or is incorporated as part of any suitable application or system, e.g., a content creation and/or content editing application; a web browsing application; a social media application; a content provider application; a 2D application; an extended reality (XR) application; a supplemental content provider; a content acquisition, recognition and/or processing application; a machine learning model or AI system; or any other suitable application or system; or any combination thereof. The CD application and/or CD system may comprise or employ any suitable number of displays; sensors or devices such as those described in FIGS. 1-13; or any other suitable software and/or hardware components; or any suitable combination thereof.

In some embodiments, the CD application may be installed at or otherwise provided to a particular computing device, may be provided via an API, or may be provided as an add-on application to another platform or application. In some embodiments, software tools (e.g., one or more software development kits, or SDKs) may be provided to any suitable party, to enable the party to implement the functionalities described herein.

As shown in FIG. 1A, the primary device 102 (e.g., Alice's device) receives a user-interface input 112 requesting to download a content item 114 (e.g., the movie “twilight”) to one or more secondary, cache devices 110 (e.g., Bob's device) for offline consumption. In one example, the primary device 102 is a laptop logged into a streaming service 116, (e.g., Netflix), using the credentials of a streaming service account 118 and the secondary device is a mobile phone logged into the same streaming service 116, (e.g., Netflix) using credentials of the same streaming service account 118. In some embodiments, the streaming service account 118 may comprise one or more profiles associated with one or more devices. In some embodiments, the primary device 102 is logged into the streaming service 116 using credentials of the streaming service account 118 under a first user profile associated with the primary device 102. In some embodiments, the primary device 102 receives a user interface input 112 selecting one or more secondary, cache devices either associated with the first user profile or another, second user profile associated with the same streaming account 118. For example, the primary device 102 (e.g., Alice's device) may receive a selection (e.g., a user interface input such as tapping, swiping, or pinching, an input from a cursor, or stylus, a voice command, camera-based gesture recognition, a server may transmit a selection to the primary device, or any other suitable means for a device to receive an input for making a selection) of a secondary, cache device (e.g., Alice's XR glasses) associated with the first user profile associated with the same streaming account 118. In another example, the primary device 102 (e.g., Alice's device) may receive a selection of a secondary, cache device 110 (e.g., Bob's device) under a second user profile associated with the same streaming account 118. In some embodiments, in response to the secondary, cache device 110 being associated with a second user profile, the streaming service server (e.g., server 108) may generate a notification at the secondary, cache device 110 prompting either approval or denial of the request to download the content item 114 to secondary, cache device 110 (e.g., Bob's device) for offline consumption.

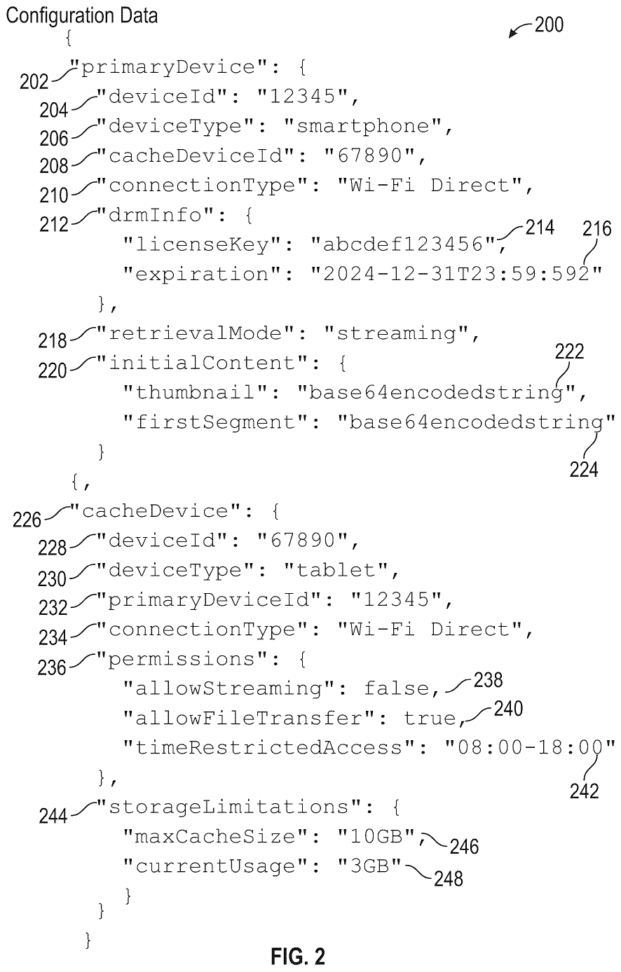

In some embodiments, the primary device 102 receives from the at least one server of the plurality of servers 108, a first configuration data 104 used to configure the primary device 102 with a permission to access the content item 114 from the secondary, cache device 110 associated with the user account 118. In some embodiments, a first configuration data 104 used to configure the primary device 102 may include details such as the device's ID, the type of connection to be used with the cache devices (e.g., Wi-Fi Direct), DRM information to ensure that only the primary device 102 can access the content, and the retrieval mode (e.g., streaming or file transfer). In some embodiments, the first configuration data 104 used to configure the primary device 102 includes a small portion of the content such as a thumbnail, a first N number of bytes, or the first N number of content segments. For example, the first configuration data 104 may include a first N number of content segments allowing for immediate playback while the remaining content is retrieved from the cache device. Examples of a first configuration data 104 used to configure the primary device 102 are described in more detail in FIG. 2.

In some embodiments, the at least one server of a plurality of servers 108 transmits, to the secondary, cache device 110 associated with the user account 118, second configuration data 106 used to configure the secondary device 110 with a permission to store the content item 114 and transmit the stored content item 114 to the primary device 102. In some embodiments, the second configuration data 106 used to configure the secondary device 110 may include details such as the device's role (e.g., secondary, cache device), permissions (e.g., permissions that restrict streaming but allow file transfers), time-based access controls, and storage limitations. For example, in some embodiments, the second configuration data 106 used to configure the secondary device 110 may include storage limitations detailing that the max cache size associated with the secondary device 110 is 10 GB and the current usage is 3 GB. Examples of a second configuration data 106 used to configure the secondary device 110 are described in more detail in FIG. 2.

In some embodiments, the primary device 102 and the secondary, cache device 110 establish a connection 120 by initiating a secure pairing process. In one example, the primary device 102 and the secondary, cache device 110 use a cryptographic key exchange protocol (e.g., Diffie Hellman, Elliptic Curve Diffie-Hellman (ECDH)) to establish a trusted relationship for secure, automatic content transfers. In some embodiments, the at least one server of the plurality of servers 108 transmits at least the portion of the content item 114 for storage at the secondary device 110 in encrypted format. In some embodiments, the first configuration data 104 comprises providing the primary device 102 with a key 122 for decryption of the at least a portion of the content item 114 in encrypted format. In some embodiments, the second configuration data 106 comprises restricting the secondary device 110 from storing the key 122 for decryption in non-transitory memory (e.g., the key may only be stored in transitory memory for the purpose of being forwarded to the primary device after which the key is deleted) of the at least a portion of the content item 114 in encrypted format, preventing the secondary device 110 from playing the at least a portion of the content item 114 at the secondary device 110. In embodiments, the secondary device 110, based on the second configuration data 106 comprises a key for decryption of the content item in encrypted format based on a request from the secondary device 110 to play the content item at the secondary device 110. In some embodiments, the second configuration data 106 configures the secondary device 110 with restrictions, such as restricting the use of the key 122 only for transfer to the primary device 102 upon a request from the primary device 102 to play the content. In some embodiments, the secondary device 110 is configured to be unable to use the stored key 122 to decrypt the at least a portion of the content item 114 stored at the secondary device 110 in encrypted format (e.g., because the key is intended only for transfer). In some embodiments, the secondary devices may receive updated configuration that allows for usage of the key for decryption (e.g., based on secondary devices becoming designated as a new primary devices). In some embodiments, the second configuration data 106 configures the secondary device 110 with restrictions such as restricting the deletion of the at least a portion of the content item stored at the secondary device 110. In some embodiments, for example, if the secondary device 110 receives a user interface input requesting removal of the content item 114 stored by the primary device 102 at the secondary device 110, the primary device 110 may generate for output a notification comprising an option to deny or confirm the removal of content item 114 stored at the secondary device 110. In some embodiments, the second configuration data 106 configures the secondary device 110 with additional restrictions such as, for example, if the secondary device 110 receives a user interface input requesting to remove the content item 114 stored by the primary device 102 at the secondary device 110, the secondary device 110 may be restricted from removing the content item 114 until the content item 114 is transferred to another device within the shared storage pool (e.g., transferred to the primary device 102, or another device within the shared storage pool).

In some embodiments, in response to the at least one server of the plurality of servers 108 confirming the secondary device selection 110, the at least one server of the plurality of servers 108 transmits for storage at the secondary device 110 at least a portion of the content item 114. In some embodiments, the at least one server of the plurality of servers 108 determines if there is sufficient storage at the designated one or more secondary, cache devices to store all portions of the requested content. In one example, the designated secondary, cache device has available storage to store all portions of the requested content item. In another example, the primary device does not have enough available storage, the at least one server of the plurality of servers identifies available storage on the designated secondary, cache devices. In another example, the first configuration data (e.g., configuration data 104) comprises an initial portion (e.g., a thumbnail, a first N number of bytes, or the first n number of segments) of the content item and the at least one server of the plurality of servers (e.g., server 108) is configure to permit the primary device 102 to play the initial portion allowing for immediate playback while the remaining content is retrieved from the secondary, cache devices 110.

In an example, the primary device 102 and/or the secondary devices 110 comprises or corresponds to a computing device, for example, a mobile device, a smartphone, or a tablet. In another example, primary device 102 and/or the secondary devices 110 comprises or corresponds to a personal laptop, personal computer, a desktop computer connected to a LAN accessing a NAS or a home storage system for centralized data storage, a smart watch or a wearable device, smart glasses, a stereoscopic display, a wearable camera, XR glasses, XR goggles, a near-eye display device, or any other suitable user equipment or computing device, or any combination thereof.

As shown in FIG. 1B, the primary device 102 (e.g., Alice's device) receives a user-interface input 124 requesting to play (e.g., stream, access, etc.) the content 114. In some embodiments, in response to the primary device 102 receiving the user-interface input 124 to play the content 114, the primary device 102 and the secondary device 110 determines, based on permissions (e.g., streaming, file transfer, etc.) based on the first configuration data 104 associated with the primary device 102 and the second configuration data 106 associated with primary device 110, if the primary device 102 may access the content 114 at the primary device 102. In some embodiments, in response to the primary device 102 receiving the user-interface input 124 to play the content 114, the primary device 102 and the secondary device 110 also determines, based on permissions (e.g., streaming, file transfer, etc.) based on the second configuration data 106 associated with the secondary device 110 if the secondary device 110 has file transfer permissions. In some embodiments, in response to the primary device 102 and secondary device 110 confirming the primary device 102 has streaming permissions and the secondary device 110 has file transfer permissions, the primary device 102 and the secondary device 110 may initiate a key exchange allowing for the primary device 102 to decrypt and stream the at least a portion of the content item 114 stored in encrypted format at the secondary device 110. In some embodiments, in response to the key exchange, the secondary device 110 may transfer to the primary device 102 the content item 114 for playback at the primary device 102.

FIG. 2 is an illustrative example of a configuration data file 200, in accordance with some embodiments of this disclosure. For example, FIG. 2 in some embodiments is implemented by CD system 100 of FIG. 1. In some embodiment, the at least one server of the plurality of servers (e.g., server 108 of FIG. 1) transmits configuration data (e.g., 104 and 106 of FIG. 1) to each of the devices (e.g., primary device 102 and secondary, cache device 110 of FIG. 1) associated with the streaming service account (e.g., 118 of FIG. 1).

In some embodiments, the configuration data 200 includes details for the primary device 202 and the cache device 226. In some embodiments the configuration data 200 includes details such as the device's ID 204 and 228, the type of connection to be used with the cache device 210 and 234 (e.g., Wi-Fi Direct), DRM information 212 to ensure that only the designated device can access the content, and retrieval modes 218 (e.g., streaming and/or file transfer).

In some embodiments, the primary device configuration data 202 includes a small portion of the content 220. In some embodiments, the small portion of the content 220 may include thumbnails 222 and/or a first N number of bytes or the first N number of content segments 224 allowing for immediate playback while the remaining content is retrieved from the cache devices.

In some embodiments, the cache device configuration data 226 specifies the devices role (e.g., “cacheDevice”), including permissions 236 that restrict streaming 238 but allow file transfers 240, as well as time-based access controls 242. In one example, Bob's device 110 of FIG. 1 is configured with the configuration data 226 associated with the cache device. Following this example, Bob's device 110 of FIG. 1 is configured, based on the configuration data 226, to not allow streaming of the content item 114, (e.g., the movie “twilight” 114 of FIG. 1), but is allowed to transfer the content item 114 to, for example, Alice's device 102 of FIG. 1.

In some embodiments, the cache device configuration data 226 includes storage limitations 244. For example, the cache device configuration data 226 specifies the storage limitations 244 have a max cache size of 10 GB and the current usage is 3 GB. In one example, a content item such as a video program is available in an ABR format, and includes multiple bitrates, multiple codecs, and multiple segments. In some embodiments, upon the primary device, for example Alice's device 102 of FIG. 1, receiving a user interface input to download such content item for offline consumption, the server, for example server 108 of FIG. 1, may select a particular bitrate and a particular codec based on the available storage space amongst the primary and cache devices selected for offline storage.

In one example, the primary device (e.g., primary device 102 of FIG. 1) may receive a user interface input (e.g., user interface input 112 of FIG. 1) to download 10 one-hour episodes of a television show and each episode is available in 1, 5, and 10 Mbps in one codec. Following this example, the devices selected for offline storage may be limited in size to 12 GB. The server (e.g., server 108 of FIG. 1) may then select 1 Mbps encode as it requires only 4.5 GB of storage instead of 22.5 GB and 45 GB for 5 Mbps and 10 Mbps, respectfully. Further, the server may optimize the bitrate selection by attempting to fill the entire storage while maximizing video quality. For instance, in one example, the server may select one episode at 10 Mbps, 1 episode at 5 Mbps, and 8 episodes at 1 Mbps, totaling 10.35 GB out of the 12 GB available amongst the devices selected for offline storage. Further, in another example, the server may also distribute the content item segments across the devices selected for offline storage regardless of their belonging to the media item. For instance, in some embodiments, the content item may be split into 300 segments. The server may transmit 100 segments to one cache device and 200 segments to another cache device of the devices selected for offline storage. In some embodiments, upon the server completing the writing of each file associated with one content item, the server may then generate a playback manifest for that content item that contains for example, URI's, for each of the distributed media segments. In some embodiments, all devices associated with the shared storage pool are always available and in close proximity to each other to allow for ad-hoc connections, for example, the devices establish a peer-to-peer connection using local communication methods such as Wi-Fi Direct, Bluetooth, or NFC, allowing for the content to be transferred directly from the one or more devices selected for offline storage to the primary, playback device.

In some embodiments, at least some of the devices associated with the shared storage pool may not be available and in close proximity to each other to allow for ad-hoc connections. In some embodiments, the server downloads the totality of a content item to at least one cache device. In some embodiments, the server distributes manifest files to all devices associated with the shared storage pool so that the streaming service server knows which devices contain which file and for example, if a device receives a user interface input requesting playback of a file that is in a portion of a device that is currently unavailable, the device in which the request was received, will output an appropriate response indicating which devices need to be turned on and put into proximity of the playback device such that an ad-hoc connection may be established. In another example, if a cache device is unavailable to transmit a content item which may be stored at the unavailable cache device, the primary device user interface or the server highlights the unavailable content, for example, by making the content distinguishable from content that is available for transfer to the primary device. In some embodiments, once the devices are within range to one another and become available, the devices may establish a secure peer-to-peer connection using local communication methods such as Wi-Fi Direct, Bluetooth, or NFC, allowing for the content to be transferred directly from the one or more devices selected for offline storage to the primary, playback device.

In some embodiments, as content is transferred from the cache devices to the primary, playback device the devices associated with the shared storage pool dynamically manage the storage of the devices by deleting portions of the content from the secondary, cache device(s) as they are successfully transferred. In one example, upon the secondary, cache device receiving an acknowledgement (“ACK”) from the primary, playback device for a specific segment of content transmitted to the primary, playback device, the primary, playback device may delete the specific segment of content from the storage of the secondary, cache device to free up space and enforce storage policies, such as limiting simultaneous transfers or optimizing device performance.

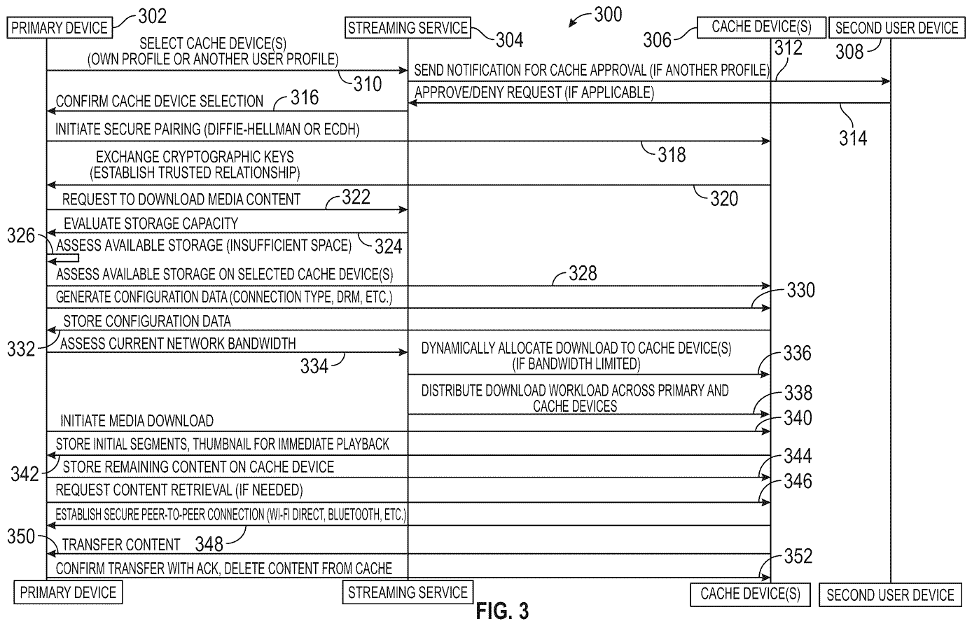

FIG. 3 shows an illustrative sequence diagram 300 for dynamically managing content across multiple devices and profiles associated with a shared streaming account based on configuration data and cache device selection, in accordance with some embodiments of this disclosure. FIG. 3, in some embodiments is implemented by CD system 100 of FIG. 1.

In some embodiments, one or more devices are logged into the same streaming service account using the credentials associated with the respective profiles. Although in this example, only two devices are illustrated (e.g., a primary device 302 and one cache device 306), in some embodiments, more than two devices logged into the same streaming service account (e.g., 5, 10, or 15 devices). In some embodiments, the streaming service account is logged into on multiple devices using the credentials of a single profile. For example, the streaming service account name Alice 118 of FIG. 1, may have a single profile (e.g., Alice) associated with the streaming service account, Alice. Three other devices (e.g., Alices phone, Alices laptop, and Alices iPad), are logged into using the log in credentials associated with Alice's profile to access the streaming service account associated with Alice. In some embodiments, the streaming service account is logged into on multiple devices using the credentials of at least two profiles. For example, the streaming service account name Alice 118 of FIG. 1, may have two profiles (e.g., Alice and Bob) associated with the streaming service account, Alice. One device (e.g., Alice's phone) may be logged into using the log in credentials associated with Alice's profile and one device (e.g., Bob's laptop) may be logged into using the credentials associated with Bob's profile to access the streaming service account associated with Alice. In some embodiments, content is managed across all of the devices logged into the same streaming account, within the CD system (referred to herein as “the shared storage pool”).

In some embodiments, a first device with the shared storage pool, is operating as the primary device 302. In some embodiments, the first device receives a user interface input selecting the first device as the primary device 302. In some embodiments, the streaming service sever 304 identifies, based on activity at the first device, that the first device is operating as the primary device 302. In some embodiments, the primary device 302 is prioritized by the streaming service server 304 to transmit the most relevant content (e.g., a thumbnail, a first N number of bytes, or the first N number of segments) to the primary device 302. In some embodiments, depending on the available storage at the primary device 302, all portions of the content item may be stored at the primary device 302. In some embodiments, depending on the available storage at the primary device 302, only a small portion of the content (e.g., initial segments) of the content may be stored at the primary device 302.

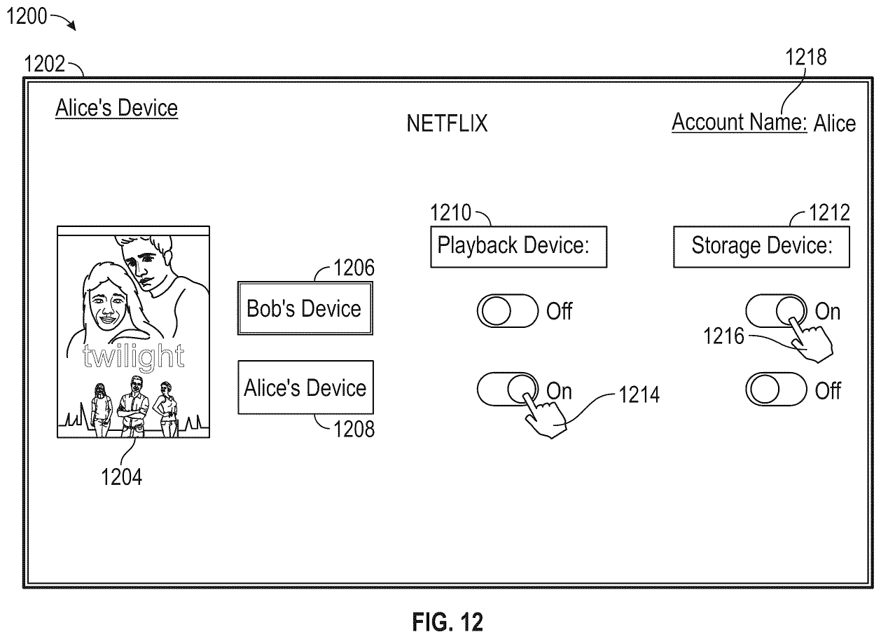

In some embodiments, the primary device 302, receives a user interface input selecting one or more secondary, cache devices 310. In some embodiments, at least one secondary, cache devices 306 receives at least a portion of a requested content item for storage. In some embodiments, the selection of the secondary, cache device 306 may be profile-based or device-specific. In some embodiments, the primary device 302, receives a user interface input selecting at least one secondary, cache device 306 of the devices logged into the streaming service account under the credentials of a single profile. For example, the primary device 302 (e.g., Alice's laptop) logged into using the credentials of a streaming service account (e.g., Alice's account) under a single profile (e.g., Alice's profile) may receive a user interface input selecting a secondary, cache device 306 (e.g., Alice's phone) associated with the single profile (e.g., Alice's profile). In some embodiments, the primary device 302, receives a user interface input selecting at least one secondary, cache device of the devices logged into the streaming service account under the credentials of a second profile. For example, the primary device 302 (e.g., Alice's laptop) logged into using the credentials of a streaming service account (e.g., Alice's account) under a first profile (e.g., Alice's profile) may receive a user interface input selecting a secondary, cache device 308 (e.g., Alice's husbands, Bob's laptop) associated with a second profile (e.g., Alice's husbands, Bob's profile). In some embodiments, the streaming service server 304 receives at the primary device 302 a selection of at least one secondary, cache device 306. In some embodiments, the selection of the roles of the devices is made through a graphical user interface such as the interface depicted in FIG. 12. In some embodiments the streaming service server 304, in response to receiving the selection of a secondary, cache device 308 logged into the streaming service account under the credentials of a second profile, transmits a notification to the secondary, cache device 308 prompting approval or denial of the request for the device to act as a secondary, cache device 312. In some embodiments, the secondary, cache device 308 logged into the streaming service account under the credentials of a second profile, transmits to the streaming service server the approval or denial of the request for the device to act as a secondary, cache device 314.

In some embodiments, streaming service server 304 transmits a confirmation to the primary device 302 of the secondary, cache device selection 316. In some embodiments, in primary device 302 initiates a secure paring process between the primary device 302 and the selected secondary, cache devices 306, using for example, cryptographic key exchange protocols such as Diffie-Hellman or Elliptic Curve Diffi-Hellman (ECDH). In response, the selected cache devices 306 exchange cryptographic keys 320 to establish a trusted relationship for secure, automatic content transfers with the primary device 302.

In some embodiments, once the secondary, cache devices are established, primary device 302, in response to receiving a user interface input selecting content to download for offline consumption, transmits the request to the streaming service server 304. Streaming service server 304 assesses the available storage at the primary device 324 to determine if there is sufficient space to store the entire requested content. In some embodiments, the streaming service server may determine primary device 302 has sufficient storage space to store all portions of the requested content item. In some embodiments, streaming service server 304 may determine primary device 302 does not have enough storage to store all portions of the requested content 326. In response to determining, primary device 302 does not have enough storage to store all portions of the requested content, streaming service server 304 assesses the available storage on the selected cache devices, regardless of the profile used to log into the streaming service account 328.

In some embodiments, the streaming service server 304 selects the appropriate secondary, cache devices based on one or a combination of factors such as, for example, available storage, the proximity of the devices using Bluetooth, Wi-Fi, or NFC, historical location patterns (e.g., monitoring the devices location via GPS), historical usage patterns, recent activity at the devices (e.g., movement detected by the inertial measurement unit (IMU)), or recent usage of the streaming application. For example, if the streaming service server 304 detects a second device (e.g., a tablet) associated with the streaming service account is nearby the primary device (e.g., a phone) by detecting the two devices are connected to the same Wi-Fi network the streaming service server may prioritize the nearby second device as the selected secondary, cache device, over another secondary device associated with the streaming service account that is not near the primary device. In another example, the streaming service server 304 may detect a second device (e.g., a tablet) associated with the streaming service account which has been recently moved (e.g., the CD system forecasts, based on historical location patterns, that the second device and the primary device will be in proximity of each other for a threshold amount of time), and shows recent usage of the streaming service application. In this example the streaming service sever 304 may prioritize this secondary device as the cache device over other secondary, cache devices associated with the streaming service account.

In some embodiments, the streaming service server 304 transmits a notification to the primary device 302 providing information as to which device(s) associated the streaming service account have been selected by the streaming service sever 304 as secondary, cache devices 306. In some embodiments, the primary device 302 may receive a user interface input selecting different secondary, cache devices.

In some embodiments, streaming service server 304 transmits configuration data 330 (e.g., configuration data 200 of FIG. 2) to the primary device 302 and the secondary, cache device(s) 306, used to configure both devices. In some embodiments, the configuration data comprises, for example, connection types, DRM information, the devices roles, and/or permission associated with the device. In some embodiments, the configuration data comprises a connection type which limits the type of connection the primary device and the secondary device(s) can establish for the transfer of the content to occur. In some embodiments, for example, the configuration data specifies the connection type of a home WiFi and therefore content can only be transferred when both the playback, primary device and the secondary, cache devices(s) are connected to the home WiFi rather than be connected, for example, over a cellar network. In some embodiments, the configuration data comprises a connection type, for example, to restrict valuable content from being transferred over public networks. For example, a provider may want to restrict the transfer of a newly, released episode from being transferred over a public network such as a cellar network. In some embodiments, the configuration data may not comprise a connection type and therefore, the transfer of content between the primary device and secondary device(s) happens regardless of a connection type. In some embodiments, the primary device 302 and the secondary cache device(s) 306 store the configuration data 332 associated with each of the devices.

In some embodiments, in addition to the streaming service server 304 evaluating storage capacity at the primary and secondary, cache device(s), the streaming service server 304 may assess the current network bandwidth on the primary device 302, calculating the estimated time required to download the content 334. In some embodiments, if the bandwidth of the connectivity is limited (e.g., poor cellular reception in an airport) and if a secondary, cache device is available and has available bandwidth, the streaming service server 304 may dynamically allocate part or all of the downloaded content to that secondary, cache device 336, distributing workload across the primary and secondary cache devices 338.

In some embodiments, the primary device 302 may receive a user interface input initiating a download of content 340 to the secondary, cache device 306. The secondary, cache device 306 may transmit, via the configuration data associated with the primary device 302, a small portion of the content such as initial segments and/or thumbnails for storage at the primary device 302 for immediate playback 342. In some embodiments, the primary device 302 may transmit, via the configuration data associated with the selected secondary, cache device(s), the remaining segments of the content initiated for download 344 at the secondary, cache device 306.

In some embodiments, the primary device 302, in response to receiving a user interface input at the primary device 302, to play the content item, transmits a request to retrieve the content 344 stored at the secondary, cache device 306. In some embodiments, in response to receiving the user interface input at the primary device 302, to play the content item, the primary device 302 establishes a secure peer-to-peer connection (e.g., Wi-Fi Direct, Bluetooth) 346 with the secondary, cache device(s) 306. In some embodiments, the secondary, cache device(s) 306, based on the second configuration data, transmits the portions of the requested stored content item 350 to the primary device 302. In some embodiments, in response to receiving the requested portions of the content item, the primary device 302 transmits an acknowledgement (“ACK”) confirming reception of the transfer of the portions of the requested stored content item 352 to the secondary, cache device 306. In some embodiments, in response to receiving the ACK at the secondary, cache device 306, the secondary, cache device 306 304 deletes the content from the storage of the secondary, cache device(s) 306.

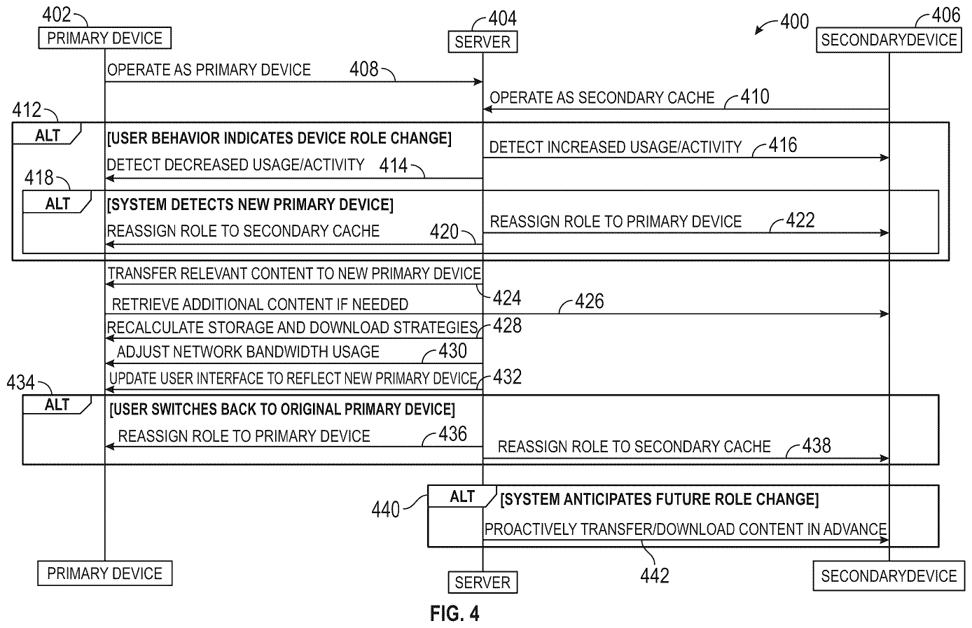

FIG. 4 shows an illustrative sequence diagram 400 for dynamic device role reassignment, in accordance with some embodiments of this disclosure. FIG. 4, in some embodiments is implemented by CD system 100 of FIG. 1.

In some embodiments, the CD system implements dynamic role reassignments, allowing the roles of the primary and secondary devices to be automatically adjusted based on real-time device behavior, context, and usage. In some embodiments, dynamically adjusting roles of the devices minimizes the need for repeated downloads across the devices. In some embodiments, once the content is downloaded and stored across the devices, the CD system can use local network transfers (e.g., Wi-Fi direct) to distribute the content across the devices without re-downloading it, reducing overall bandwidth usage and network congestion.

In some embodiments, primary device 402 receives from server 404 a first configuration data (e.g., configuration data 202 of FIG. 2) used to configure the devices role as primary device 402. Accordingly, in one example, primary device 402, based on the first configuration data, will operate as primary device 408. In some embodiments, secondary device 406 receives from server 404 a second configuration data (e.g., configuration data 226 of FIG. 2) used to configure the devices role as secondary, cache device 406. Accordingly, in one example, secondary device 406, based on the second configuration data, will operate as secondary device 410.

In some embodiments, the server 404 detects that the device designated as the secondary, cache device 406 may become the primary, playback device 402 under certain conditions. In some embodiments, the server 404 detects this change in device role in real-time. In one example, the server 404 detects a change in activity at either the first or the secondary device 412. For instance, in some embodiments, a first device in which a user interface input request was received initially selects a first device as the primary device 402 (e.g., Alice's laptop 102 of FIG. 1) and a second device as the secondary, cache device 406 (e.g., Bob's mobile phone 110 of FIG. 1), but the server 404 (e.g., server 108 of FIG. 1) detects an increased usage/activity 416 of the secondary, cache device 406 and a decreased usage/activity 414 at the primary device 402. In response to the server detecting this usage/activity change amongst the devices, the server may, based on the detected increased usage, transmit updated configuration data to each of the devices, specifying an updated role assignment 418. For example, server 404 transmits updated configuration data to the primary device 402 updating the role of the device to secondary cache 420 and transmits updated configuration data to the secondary device 406 updating the role of the device to primary device 422. In some embodiments, the server may detect a shift in usage based on various indicators such as increased activity on a device, device location, application usage patterns, or user interface input on a primary, playback device indicating that a specific device will be the updated primary device for a period of time.

In some embodiments, upon detecting this role assignment change, the server 404 makes several automated adjustments between the devices within the shared storage pool. In some embodiments, the server 404 prioritizes the transfer of relevant content from the initial primary device 402 to the new primary device 406. For example, the new primary device 406, based on the updated configuration data, contains an initial portion (e.g., a thumbnail, a first N number of bytes, or the first n number of segments) of the content item allowing for immediate playback at the new primary device 406. In some embodiments, the server 404 transfers any content that was previously downloaded to the initial primary device 402 but is now needed on the new primary device 406 due to its new role. In some embodiments, the content is securely and efficiently transferred between the primary device 402 and the secondary device 406 using established secure communication methods such as Wi-Fi Direct or Bluetooth, enabling the newly designated primary device to immediately playback the content. In some embodiments, the new primary device 406 retrieves additional content from the new secondary device 402 if needed 426.

In some embodiments, server 404 recalculates storage and download strategies 428 based on the new device hierarchy. In one example, if the new primary device 406 receives a user interface input requesting additional content be downloaded, the server 404 prioritizes the new primary device 406 for initial segments of the content to be stored, using the new secondary device as the cache if the new primary device's storage becomes limited. For example, two devices, a laptop and a phone, may be logged into using the credentials of Alice's streaming service account. While at home, before going to the airport, Alice's laptop received a user interface input to download a movie to view for offline consumption, and all portions of the movie were downloaded to Alice's laptop. But while at the airport, server 404 detects a change in activity between the laptop and the phone, indicating that the phone is receiving more activity than the laptop. Based on this detection, server 404, reassigns the roles of the two devices, transmitting updated configuration data for each device. In response, Alice's laptop transfers all relevant content (e.g., initial segments and/or thumbnails of content) to Alice's phone to ensure that all relevant content is available on the device in which is primarily used at a given time.

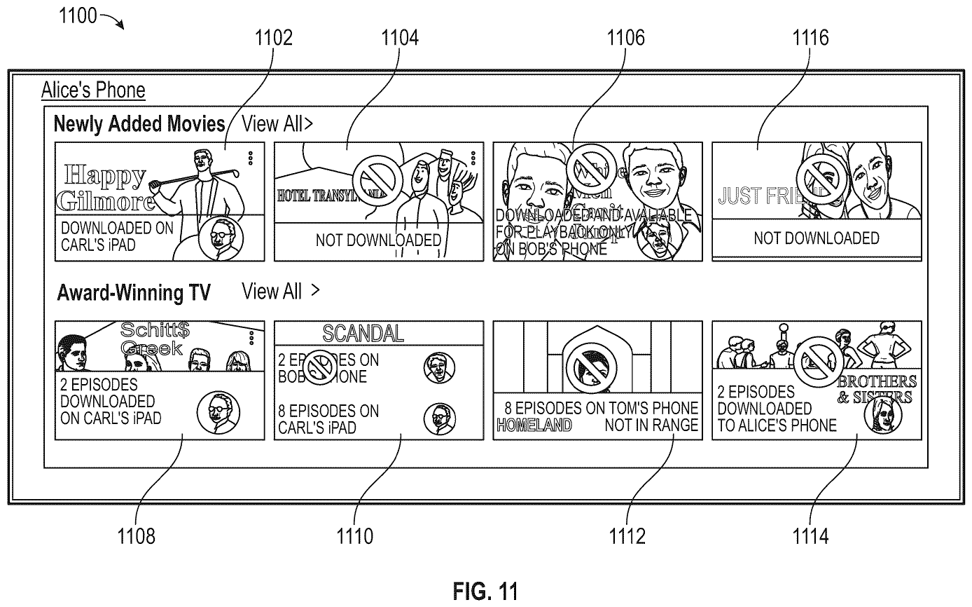

In some embodiments, the server 404 provides for output a graphical interface (e.g., graphical interface 1100 of FIG. 11) used to manage content across the devices associated with the streaming service account. In some embodiments, the server 404 updates the graphical interface 432 of the new primary device 406 to ensure that any actions or controls for content management received at the new primary device 406 are directed towards the new primary device 406 rather than the new secondary device 402. In some embodiments, the server 404 automatically updating the user interface on the new primary device 406 eliminates the need to manually adjust the settings for each of the devices associated with the streaming service account.

In some embodiments, the server 404 again detects a change in usage behavior 434 amongst the devices within the shared storage pool. For example, the initial primary device 402 may receive increased user interface inputs indicating an increased usage/activity compared to the new primary device 406. Upon detecting this change server 404 transmits new configuration data to both the primary device 402 reassigning its role as primary device 436 and to the secondary device 406 reassigning its role as secondary cache device 438. For example, following the example previously, after the flight, the server 404 may detect that Alice's laptop is now receiving more user interface inputs than her mobile device, and therefore, reassign the laptop, based on new configuration data transmitted from server 404, as the primary device 402 and Alice's phone as the secondary cache device 406.

In some embodiments, the server 404 anticipates which devices amongst the shared storage pool will be assigned the role of primary device, for example, when a device receives an increased activity before such as moving from a laptop to a phone before a flight. In some embodiments, the server 404 may proactively transfer or download, via transferring updated configuration data, content to the anticipated primary device in advance of a real-time detection. The server 404 proactively reassigning role assignments and proactively caching content reduces server congestion by reducing the need for the devices to initiate requests from the server which requires expending additional bandwidth and causing extra computing strain on the server, allowing for the primary device to have immediate access to requested content.

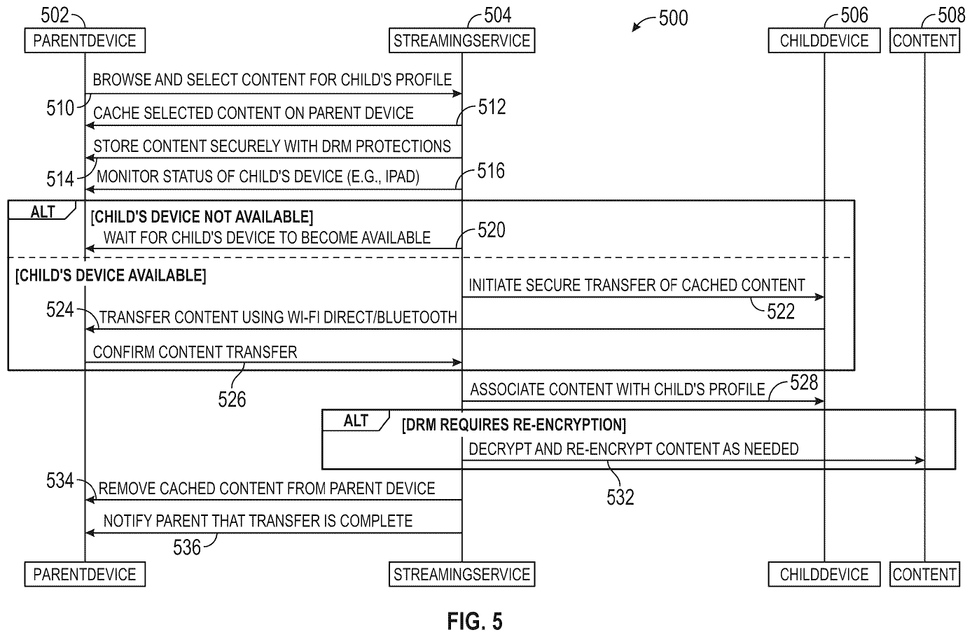

FIG. 5 shows an illustrative sequence diagram 500 for managing and preparing content for profiles associated with the same streaming service account, in accordance with some embodiments of this disclosure. FIG. 5, in some embodiments is implemented by CD system 100 of FIG. 1.

In some embodiments, a first device is logged into using credentials of a streaming service account under a first profile (e.g., a parent's profile), (referred to herein as “the parent device) 502. In some embodiments, a second device is logged into using credentials of the same streaming service account but under a second profile (e.g., a child's profile), (referred to herein as “the child's device). In some embodiments, the parent device 502 receives a user interface input for browsing and selecting content for a child's profile 510 associated with the same streaming service account. In some embodiments, in response to the selection of a content item at the parent device 502, the streaming service server 504 caches, based on a configuration data associated with the parent device 502, the selected content on the parent's device 512. In some embodiments, without needing to switch to the child's profile associated with the same streaming service account or without the child's device 506 receiving the request to download the selected content, the parent device 502 can request specific content for caching within the parent's profile. In some embodiments, the configuration data transmitted from the streaming service server 504 to the parent device 502, in response to transmitting the selected content, comprises DRM protections 514.

In some embodiments, once the configuration data comprising the content is received and cached at the parent device 502, the streaming service server 504 monitors the status of the child's device 516. In some embodiments, the streaming service server 504 waits for the child's device 506 to become available 520 and the specific content remains cached on the parent's device 502. In some embodiments, the streaming service server 504 detects the child's device is available for transfer (e.g., detecting the child's device 506 is near the parent device 502, the child's device 502 and the parent device 506 are connected to the same network, or otherwise accessible) and initiates a secure, automatic transfer of the cached content 522 from the parent device 502 to the child's device 506. In some embodiments, the transfer is conducted using secure peer-to-peer communication methods such as Wi-Fi Direct or Bluetooth, ensuring that the content is delivered efficiently and securely to the intended device. In some embodiments, the parent device 502 confirms content transfer 526 with the streaming service server 504.

In some embodiments, the streaming service server 504 automatically associates the transferred content with the child's profile 528, ensuring that the content is accessibly under the correct profile and settings associated with the streaming service account.

In some embodiments, during the transfer of the content from the parent's device 502 to the child's device 506, the streaming service server 504 manages the data to ensure it is decrypted and re-encrypted if necessary 532, according to the requirements of the streaming services DRM.

In some embodiments, the streaming service server 504 transmits to the parent device 502 a notification specifying that the transfer of the content item to the child's device 506 is complete. In some embodiments, the notification comprises and indication that the content is ready for playback at the child's device 506. In some embodiments, the streaming service server 504 removes the cached content from the parent device 502 once the content is transferred to the child's device 506.

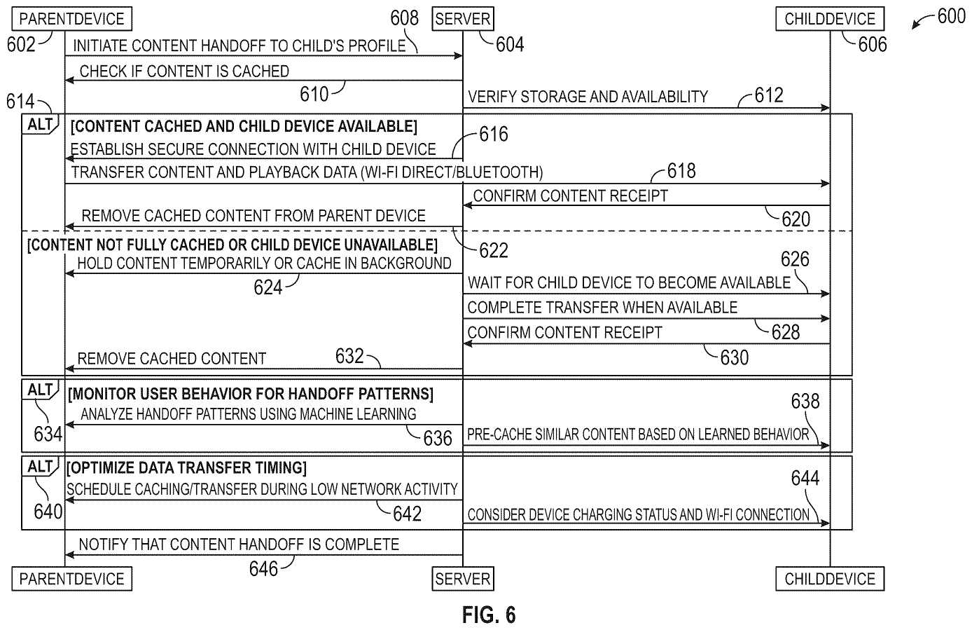

FIG. 6 shows an illustrative sequence diagram 600 for profile-based content transfer and associated data between profiles and their respective devices associated with a shared streaming account, in accordance with some embodiments of this disclosure. For example, FIG. 6 in some embodiments is implemented by CD system 100 of FIG. 1.

In some embodiments, a device is logged into using credentials of a streaming service account under a profile belonging to a parent (“the parent device) 602. In some embodiments, the parent device 602 receives a user interface input to play a movie at the parent device 602. In some embodiments, it may be desired to have the movie play on the device logged into using the same credentials of a streaming service account as the parent but under the profile of a child (“the child device) 606. In this example, the parent device 602 receives a user interface input initiating the content handoff to the child's profile 608 logged into on the child's device 606. The server 604 receives this request to handoff the content and performs a check to see if the content is cached 610 at the parent device 602. In some embodiments, in response to receiving the handoff request from the parent device 602, the server 604, verifies the storage and availability 612 at the child device 606. In some embodiments, the server 604 permits the parent device 602 to initiate a content handoff, such as a movie, along with its playback state and associated data to be transferred to the child's profile and device. In some embodiments, the handoff does not require the content to be manually downloaded at the child's device 606 saving the server 604 from congestion.

In some embodiments, in response to the server 604 verifying the content is cached at the parent device 602 and the child's device 606 being available and having storage 614, the system 604 establishes a peer-to-peer connection between the parent device 602 and the child's device 606, using technologies such as Wi-Fi Direct or Bluetooth. In some embodiments, once the connection is established, the parent device 602 transfers the cached content, including the current playback position and any bookmarks, directly to the child's device 606. In some embodiments, the data transfer is encrypted to ensure security and efficiency.

In some embodiments, if the content is not fully cached on the parent's device 602 or if the child's device 606 is not immediately accessibly, the server 604 can temporarily hold the content on the parent's device 602 while waiting for the child's device 606 to become available 626. In some embodiments, the server 604 can continue streaming the content on the parent's device 602 while caching the data in the background. In some embodiments, once the child's device 606 is available the server 604 completes the transfer, making the content available under the child's profile 628 logged into on the child's device 606.

In some embodiments, the child's device 606 confirms content receipt 630 by, for example, sending an acknowledgement to the server 604. In some embodiments, once the server 604 receives the acknowledgement from the child's device 606, the server 604 may automatically remove the content from the parent's device 602, freeing up storage space and ensuring that the content is only accessible under the appropriate profile.

In some embodiments, the server 604 monitors and analyzes the behavior of each device to recognize patterns 634 such as frequent handoffs to specific types of content between devices. For example, the server 604 may detect that the parent device 602 often requests that children's movies be transferred from the parent device 602 to the child's device 606 and begins to identify this behavior as a pattern. The server 604, in some embodiments, may use machine learning algorithms to analyze factors 636, for example, at the parent device 602, such as content involved, the timing of handoff requests, and the devices typically associated with the handoff requests.

In some embodiments, the server 604, based on this learned behavior, may proactively cache related content 638 on either of the devices or both the parents device 602 and the child's device 606 before a handoff request is received at the server 604. In one example, the server 604 learns that the parent device 602 regularly requests handoff of new Disney movies to the child's device 606. In response, the server 604 may begin pre-caching similar new releases on both devices as soon as they are available. In some embodiments, the server 604 pre-caches in the background, ensuring that the content is available for a quick handoff without the need for the server 604 to make additional downloads when the handoff is initiated.

In some embodiments, the server 604, to optimize the timing of these data transfers and reduce network congestion 640, schedules the caching and transfer operations during periods of low network activity 642. For example, the server 604 may wait until both devices are connected to the same Wi-Fi network during off-peak hours, such as late at night or early in the morning, to perform the data transfer 644. In some embodiments, the server 604 considers other contextual factors, such as whether the devices are plugged in and charging, to minimize the battery usage during the content transfer 644. In some embodiments, the server 604 notifies the parent device 602 that the content handoff is complete 646.

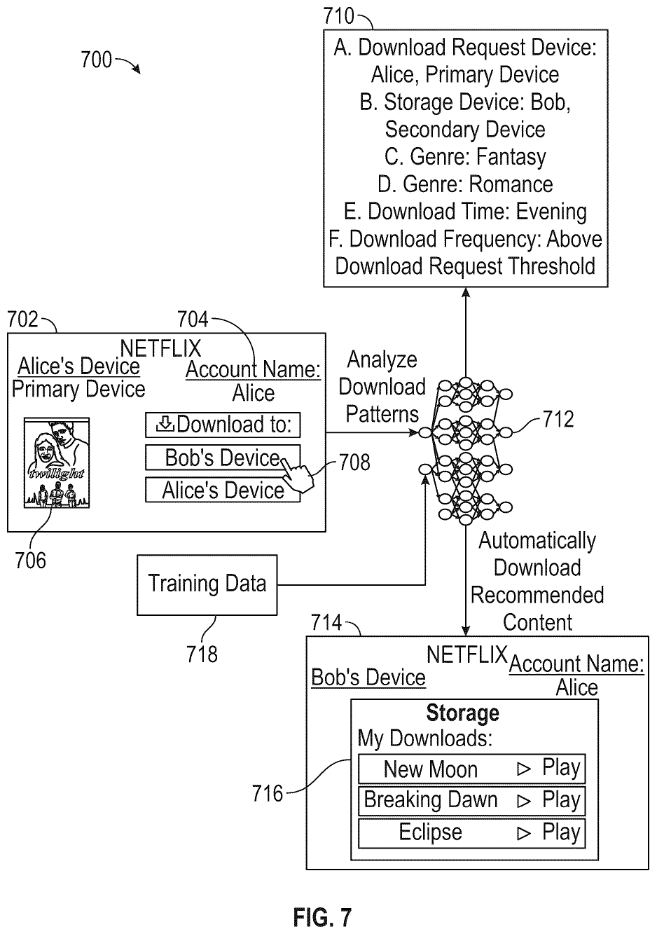

FIG. 7 is an illustrative example 700 of proactively caching content to specific devices based on learned behavior, in accordance with some embodiments of this disclosure. FIG. 7, in some embodiments is implemented by CD system 100 of FIG. 1.

In some embodiments, a first device (e.g., Alice's device) 702, logged into a streaming service account using the credentials of the streaming service account 704, receives a user interface input 708 requesting a content item (e.g., “twilight”) be downloaded to a second device (e.g., Bob's device) 714. In one example, Alice's device 702 may have started streaming the movie but has received a user interface input request halfway through the streaming of the movie to transfer the movie and the playback data to Bob's device. In some embodiments, the first device (e.g., Alice's device) 702, transmits this request to the server associated with the streaming service. In some embodiments, the server (e.g., sever 604 of FIG. 6), based on receiving requests from the first device (e.g., Alice's device) 702, has detected a pattern associated with the first device 702. In some embodiments, the server monitors and analyzes activity at each of the devices in the shared storage pool to use technology such as machine learning algorithms to analyze factors such as the types of content involved, the timing of the handoffs, and the devices typically involved in the handoff requests. For example, in some embodiments, the server, using machine learning techniques, after analyzing Alice's device for a threshold period of time, determines that Alice's device 702, frequently transmits a request to transfer fantasy and romance movies 710 to Bob's device 714. In some embodiments, the server, using machine learning techniques, determines that the Alice's device 702, frequently transmits a request to transfer movies to Bob's device 714 in the evenings 710. In some embodiments, the server may determine, using machine learning techniques, that requests are frequently received to download fantasy and romance movies, during the evening to Bob's device is above a threshold in which other download requests are received 710.

In some embodiments, the server, extracts this information 710 such as, for example, the devices involved in the handoff requests, the genre of the content involved in the handoff request, the download time the request was received, and the frequency for which the download requests are made, to be used by machine learning model 712 to identify patterns associated with, for example, Alice's device 702. In some embodiments, the server (e.g., server 108 of FIG. 1) may be configured to input, to machine learning model 712, data associated with, or representative of, at least one content item 706 and based on such input(s), machine learning model 712 may output recommended content 716 (e.g., content that is related to content item 706). For example, machine learning model 712 may be trained using training data 718 to receive as input data (e.g., a vector with any suitable number of dimensions) corresponds to content item 706. The training data may comprise any number of download request information (e.g., download time, download frequency, download request device, download transfer device, playback device, etc.), metadata (e.g., title, cast, genre, etc.), content features (e.g., themes, keywords/tags, moods, etc.), interaction data (e.g., ratings, watch history, click through data, etc.), geolocation, textual and visual features, and engagement associated with content item 706. In some embodiments, the server may be configured to employ any suitable computer implemented technique (e.g., one or more machine learning models, and/or heuristic techniques) to extract data from requests received from devices within the shared storage pool. In some embodiments, machine learning model 710 may be, for example, a neural network, an encoder transformer, a GPT4-V model, a BLIP-2 model, an OTTER model, an MPLUG-OWL model, VGGNet16, LlaMa-Adapter v2, or any other suitable machine learning model, or custom implementations of a machine learning model, or any combination thereof, for identifying patterns associated with download requests from devices within the shared storage pool. In some embodiments, such model(s) may be coupled with a large language model (LLM), a default prompt with any other suitable prompt, or any other suitable input. In some embodiments, a training dataset for machine learning model 712 may comprise pairs of natural language descriptions and associated visual elements (e.g., images or frames of video) and/or text elements, based on which machine learning model 712 may learn patterns and inferences for determining outputs for future inputs. In some embodiments, the extracted data associated may be stored in a data structure (e.g., a database, a knowledge graph or other graph data structure, a semantic map, or any suitable data structure or any combination thereof).

In some embodiments, based on this learned behavior, the server may proactively cache related content on, for example, Bob's device 714. For example, the server, based on the machine learning model detecting a pattern at Alice's device, automatically downloads content that is related to the movie “twilight” to Bob's device 716, such as the other movies in the “twilight” series, “New Moon”, “Breaking Dawn”, and “Eclipse”. In some embodiments, the server pre-caches the related content in the background, reducing network congestion. For example, the server may cache the related content on the secondary device, in advance of receiving a request to download such related content from the primary device while the server is not under a heavy network load such as during off-peak hours or when the secondary device is not active. In some embodiments, this pre-caching reduces the strain on the network when multiple requests are transmitted to access content at peak times and avoids buffering or lag due to the network congestion.

FIGS. 8-9 show illustrative devices, systems, servers, and related hardware for generating a multi-layer image, in accordance with some embodiments of this disclosure. FIG. 8 is a diagram of an illustrative system 800, in accordance with some embodiments of this disclosure. Computing devices 807, 808, 810 (which may correspond to, e.g., computing device 900 or 901 of FIG. 9) may be coupled to communication network 809. Communication network 809 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 809) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 302-11x, etc.), or other short-range communication via wired or wireless paths. The computing devices may also communicate with each other directly through an indirect path via communication network 809.

System 800 may comprise media content source 802, one or more servers 804, and/or one or more edge computing devices. In some embodiments, system or application (e.g., CD application) may be executed at one or more of control circuitry 811 of server 804 (and/or control circuitry of computing devices 807, 808, 810 and/or control circuitry of one or more edge computing devices). In some embodiments, the media content source and/or server 804 may be configured to host or otherwise facilitate video communication sessions between computing devices 807, 808, 810 and/or any other suitable computing devices, and/or host or otherwise be in communication (e.g., over network 809) with one or more social network services.

In some embodiments, server 804 may include control circuitry 811 and storage 814 (e.g., RAM, ROM, Hard Disk, Removable Disk, etc.). Storage 814 may store one or more databases. Storage 814 may store in a non-transitory memory, instructions for the CD application. Server 804 may also include an input/output path 812. I/O path 812 may include or correspond to input circuitry and/or output circuitry. I/O path 812 may be used to send and receive commands, requests, and other suitable data. I/O path 812 may provide content (e.g., content items), machine learning model inputs and/or outputs, device information, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically control circuitry) to one or more communications paths. I/O path 812 may consist of circuitry that facilities the transfer of data between components within the system.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

FIG. 9 shows generalized embodiments of illustrative computing devices 900 and 901, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 901 may be a user television equipment system or device.

User television equipment device 901 may include set-top box 915. Set-top box 915 may be communicatively connected to microphone 916, Audio output equipment (e.g., speaker or headphones 914), and display 912. In some embodiments, microphone 916 may receive audio corresponding to a voice of a user providing input. In some embodiments, display 912 may be a television display or a computer display. In some embodiments, set-top box 915 may be communicatively connected to user input interface 910. In some embodiments, user input interface 910 may be a remote control device. Set-top box 915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 8. In some embodiments, computing device 900 may comprise any suitable number of sensors (e.g., gyroscope or accelerometer, etc.), and/or a GPS module (e.g., in communication with one or more servers and/or cell towers and/or satellites) to ascertain a position of computing device 900. In some embodiments, computing device 900 comprises a rechargeable battery that is configured to provide power to the components of the device.

Each one of computing device 900 and computing device 901 may receive content and data via input/output (I/O) path 902. I/O path 902 may provide content (e.g., broadcast programming, on-demand programming, Internet content, content available over a local area network (LAN) or wide area network (WAN), and/or other content) and data to control circuitry 904, which may comprise processing circuitry 906 and storage 908. Control circuitry 904 may be used to send and receive commands, requests, and other suitable data using I/O path 902, which may comprise I/O circuitry. I/O path 902 may connect control circuitry 904 (and specifically processing circuitry 906) to one or more communications paths (described below). I/O functions may be provided by one or more of these communications paths, but are shown as a single path in FIG. 8 to avoid overcomplicating the drawing. While set-top box 915 is shown in FIG. 9 for illustration, any suitable computing device having processing circuitry, control circuitry, and storage may be used in accordance with the present disclosure. For example, set-top box 915 may be replaced by, or complemented by, a personal computer (e.g., a notebook, a laptop, a desktop), a smartphone (e.g., computing device 900), an XR device; a tablet; a network-based server hosting a user-accessible client device; a non-user-owned device; any other suitable device; or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 904 executes instructions for the system or application stored in memory (e.g., storage 908). Specifically, control circuitry 904 may be instructed by the system or application to perform the functions discussed above and below. In some implementations, processing or actions performed by control circuitry 904 may be based on instructions received from the system or application.

In client/server-based embodiments, control circuitry 904 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 908, and executed by control circuitry 904 of a computing device 900.

In some embodiments, the system or application may be a client/server application where only the client application resides on device 900 (e.g., computing device 102), and a server application resides on an external server (e.g., server 804). For example, the system or application may be implemented partially as a client application on control circuitry 904 of device 900 and partially on server 804 as a server application running on control circuitry 811. Server 804 may be a part of a local area network with one or more of computing devices 900, 901 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 804 and/or an edge computing device), referred to as “the cloud.” Device 900 may be a cloud client that relies on the cloud computing capabilities from server 804 to determine whether processing should be offloaded from the mobile device, and facilitate such offloading. When executed by control circuitry of server 804, the system or application may instruct control circuitry 811 to perform processing tasks for the client device and facilitate the analysis of content items. The client application may instruct control circuitry 904 to determine whether processing should be offloaded.

Control circuitry 904 may include communications circuitry suitable for communicating with a server, edge computing systems and devices, a table or database server, or other networks or servers The instructions for carrying out the above-mentioned functionality may be stored on a server (which is described in more detail in connection with FIG. 8. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 8). In addition, communications circuitry may include circuitry that enables peer-to-peer communication of computing devices, or communication of computing devices in positions remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as the system or application data described above. Storage 908 may store in non-transitory memory instructions for CD application. Nonvolatile memory may also be used (e.g., to launch a boot-up routine and other instructions). Cloud-based storage, described in more detail in relation to FIG. 8, may be used to supplement storage 908 or instead of storage 908.

Control circuitry 904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 904 may also include scaler circuitry for upconverting and downconverting content into the preferred output format of computing device 900. Control circuitry 904 may also include digital-to-analog converter circuitry and analog-to-digital converter circuitry for converting between digital and analog signals. The tuning and encoding circuitry may be used by computing device 900, 901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from computing device 900, the tuning encoding circuitry (including multiple tuners) may be associated with storage 908.

Control circuitry 904 may receive instruction from a user by way of user input interface 910. User input interface 910 may be any suitable user interface, such as a remote control, mouse, trackball, keypad, keyboard, touch screen, touchpad, stylus input, joystick, voice recognition interface, or other user input interfaces. Display 912 may be provided as a stand-alone device or integrated with other elements of each one of computing device 900 and computing device 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to set-top box 915.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of computing device 900 and computing device 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters, words, terms, or numbers that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card.

The system or application may be implemented using any suitable architecture. For example, it may be a stand-alone application wholly-implemented on each one of computing device 900 and computing device 901. In such an approach, instructions of the application may be stored locally (e.g., in storage 908), and data for use by the application is downloaded on a periodic basis (e.g., from an out-of-band feed, from an Internet resource, or using another suitable approach). Control circuitry 904 may retrieve instructions of the application from storage 908 and process the instructions to provide the functionality, and generate any of the displays, discussed herein. Based on the processed instructions, control circuitry 904 may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, historical interactions by the user, and/or any other suitable data. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the system or application is a client/server-based application. Data for use by a thick or thin client implemented on each one of computing device 900 and computing device 901 may be retrieved on-demand by issuing requests to a server remote to each one of computing device 900 and computing device 901. For example, the remote server may store the instructions for the application in a storage device. The remote server may process the stored instructions using circuitry (e.g., control circuitry 904) and generate the displays discussed above and below. The client device may receive the displays generated by the remote server and may display the content of the displays locally on computing device 900. This way, the processing of the instructions is performed remotely by the server while the resulting displays (e.g., that may include text, a keyboard, or other visuals) are provided locally on computing device 900. Computing device 900 may receive inputs from the user via input interface 910 and transmit those inputs to the remote server for processing and generating the corresponding displays. For example, computing device 900 may transmit a communication to the remote server indicating that an up/down button was selected via input interface 910. The remote server may process instructions in accordance with that input and generate a display of the application corresponding to the input (e.g., a display that moves a cursor up/down). The generated display is then transmitted to computing device 900 for presentation to the user.

In some embodiments, the system or application may be downloaded and interpreted or otherwise run by an interpreter or virtual machine (run by control circuitry 904). In some embodiments, system or application may be encoded in the ETV Binary Interchange Format (EBIF), received by control circuitry 904 as part of a suitable feed, and interpreted by a user agent running on control circuitry 904. For example, the system or application may be an EBIF application. In some embodiments, the system or application may be defined by a series of JAVA-based files that are received and run by a local virtual machine or other suitable middleware executed by control circuitry 904. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

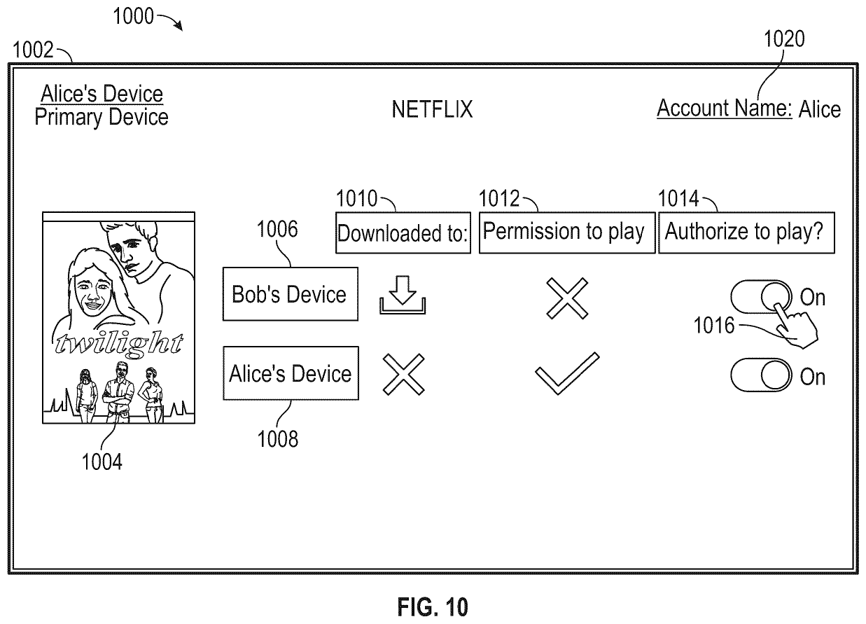

FIG. 10 is an illustrative example of a graphical interface 1000 to manage content storage and transfer across multiple devices and profiles associated with a shared streaming account, in accordance with some embodiments of this disclosure. FIG. 10, in some embodiments is implemented by CD system 100 of FIG. 1.

In some embodiments, a graphical interface 1000 is provided for output at, for example, Alice's device, which is the primary device 1002. In some embodiments, Alice's device 1002, is communicatively coupled to a server (e.g., server 804 of FIG. 8), e.g., via network 809 of FIG. 8. In this manner, server 804 of FIG. 8 may provide to Alices device 1002 information about content that was downloaded for offline consumption. As is illustrated in this example, the movie “twilight” 1004 is downloaded to 1010 Bob's device 1006 and not to Alices device 1008. Further, in this example, Bob's device 1006 does not have permission to play 1012 the movie but Alices device 1008 does have permission to play the movie. Even further, the graphical interface may output an option (e.g., a toggle) to authorize devices associated with the shared storage pool to play the movie 1014. In some embodiments, only the primary device is configured to authorize other devices within the shared storage pool to play the content. In some embodiments, the graphical interface 1000 may output any element used to switch between two possible states in order to authorize devices to play the content. In some embodiments, the primary device may authorize one or more secondary, cache devices with the authority to authorize other devices within the shared storage pool to play the content.

In some embodiments, the graphical interface includes information such as on which devices within the shared storage pool the content (e.g., the movie “twilight”) is downloaded to 1010, which devices within the shared storage pool have permission to play the movie 1012, and an option to authorize devices within the shared storage pool to play the content 1014.

FIG. 10 is an illustrative example of a graphical interface to manage content storage and transfer across multiple devices and user profiles associated with a shared streaming account, in accordance with some embodiments of this disclosure. FIG. 10, in some embodiments is implemented by CD system 100 of FIG. 1.

In some embodiments, the graphical interface 1000 is output at a device 1002 (e.g., Alice's device, the primary device) logged into using the credentials of a streaming service account 1020. The graphical interface 1000 outputs settings associated with the content 1004 (e.g., the movie “twilight”) such as information regarding which devices associated with the streaming service account the content 1004 is downloaded to 1010, which devices have permission to play the content 1012, and which devices are authorized to play the content 1014. In some embodiments, the graphical interface 1000 is updated by the streaming service server in response to the roles of the devices associated with the streaming service account. In some embodiments, the streaming service server (e.g., server 108 of FIG. 1) may output settings that are different based on the roles of each of the devices. For example, as shown in this illustrative example, only the primary device 1002, may output an authorize to play setting 1014, ensuring that the primary device 1002 is prioritized over the secondary devices 1006 and 1008 associated with the user account 1020 so that the media management is controlled by the primary device 1002.

As shown in this illustrative example, the graphical interface 1000 outputs at Alices device 1002 logged into using the credentials associated with the streaming service account 1020 (e.g., Alices Account) displays the settings associated with the content 1004 (e.g., the movie “twilight”). In some embodiments, following this illustrative example, the graphical interface 1000 outputs information detailing that the movie “twilight” is downloaded to selected device 1006 (e.g., device 110 of FIG. 1) and that selected device 1006 (e.g., device 110 of FIG. 1) does not have permission to play the movie “twilight” 1012. Further, this example illustrates that device 1002, may receive a user interface input 1016, updating the settings associated with each device (e.g., toggling the authority of each device to play the content). Although only two devices are shown in this illustrative example, device 1006 and device 1008, it should be understood the two devices are for illustrative purposes only and multiple devices (e.g., five, ten, fifteen, twenty, etc.) may be associated with the streaming service account 1218.

In some embodiments, as shown in this illustrative example, the graphical interface 1000 outputs information detailing that the movie “twilight” is not downloaded to device 1008 (e.g., device 102 of FIG. 1) but that device 1008 (e.g., device 102 of FIG. 1) does have permission to play the movie “twilight” 1012. Further, this example illustrates that device 1008 (e.g., device 102 of FIG. 1), currently is authorized to play the movie “twilight” based on the toggle being in the “on” position but may receive a user interface input 1016, updating the settings associated with each device (e.g., toggling the authority of each device to play the content). It should be understood, that this graphical interface 1000 is shown for illustrative purposes and the graphical interface 1000 may provide any settings necessary for each of the devices associated with the streaming service account (e.g., streaming service account 1010) to manage the content associated with the streaming service account.

FIG. 11 is an illustrative example of graphical interface 1100 to manage content storage and transfer across multiple devices and user profiles associated with a shared streaming account, in accordance with some embodiments of this disclosure. FIG. 11, in some embodiments is implemented by CD system 100 of FIG. 1.

In some embodiments, a graphical interface 1100 is provided for output at, for example, Alice's phone (e.g., device 102 f FIG. 1) within the shared storage pool. In some embodiments, a graphical interface 1100 is provided for output at each of the devices (e.g., device 110 of FIG. 1) within the shared storage pool. In some embodiments, the graphical interface 1100 display may be provided for output at any of the devices within the shared storage pool and the display may vary based on how each of the devices are configured based on the configuration data associated with each device (e.g., information within the configuration data such as DRM information, the retrieval mode, permissions, etc.). For example, a graphical interface associated with Bob's phone may display that none of the content downloaded to the shared storage pool, even if the content is downloaded to Bob's phone, is available for playback on Bob's phone because Bob's phone is not configured, based on Bob's phone configuration data, to play any of the downloaded content and only Alice's phone is configured to play the content. In another illustrative example, a graphical interface associated with Carl's iPad may indicate that, for example, the movie “Happy Gilmore” downloaded to Carl's iPad 1102, two episodes of the show “Shitt's Creek” downloaded on Carl's iPad 1108, the two episodes of the show “Scandal” downloaded to Bob's phone 1110, 8 episodes of the show “Scandal” downloaded on Carl's iPad 1110, and the two episodes of “Brothers and Sisters” downloaded to Alice's Phone 1114 are available for playback on Carl's device. Although, following this example, the movie “White Men Can't Dance” 1106, is not permitted for playback at Carl's iPad because, as indicated by the graphical interface, it is only available for playback at Bob's phone.

In some embodiments, as illustrated in this example, the graphical interface 1100 provided for output at Alice's phone illustrates four devices (e.g., Alice's Phone, Bob's Phone, Carl's iPad, and Tom's phone), using their credentials associated with their profile in a streaming service account (e.g., streaming service account 118 of FIG. 1), are logged into the same streaming service account (e.g., streaming service account 118 of FIG. 1). The graphical interface outputs an indication of what content is available and not available when a device is operating offline. In some embodiments, the graphical interface may output an indication of which devices the content is stored, and if the content is readily available to be accessed by the playback device.

As illustrated in this example, Alice's phone outputs a graphical interface 1100 indicating what content is readily available and not available to be played back by Alice's phone. For example, the movie “Happy Gilmore” is indicated as downloaded on Carl's iPad and is available for playback at Alice's phone. In some embodiments, continuing with this illustrative example, the graphical interface 1100 illustrates that this movie is downloaded on Carl's iPad with text. In some embodiments, the graphical interface illustrates that this movie is downloaded on Carl's iPad by an icon associated with Carl's profile. In some embodiments, the graphical interface illustrates that this movie is downloaded to a specific device by either a text, an icon, a combination of a text and an icon, or any other reasonable indication detailing on which devices the content is downloaded.

In another illustrative example, the graphical interface 1100 illustrates that the movie “Hotel Transylvania” 1104 and the movie “Just Friends” are not downloaded to any of the four devices. Continuing with this example, the graphical interface 1100 displays “White Men Can't Jump” is downloaded on Bob's Phone 1106 but is not available for playback at Alice's phone. In some embodiments, content (e.g., the movie “White Men Can't Dance”) may be unavailable to a specific device associated with the streaming account and may only be played at specific devices based on the configuration data (e.g., Alice's phone is configured, based on the configuration data, permissions that restrict streaming of the content item “White Men Can't Dance” at Alice's phone but allow file transfers). For example, in some embodiments, the movie “White Men Can't Dance” 1106 is not available for playback on Alice's phone but is available for playback on Bob's phone based on Alice's and Bob's phone configurations, based on the permissions within the configuration data associated with each device. In some embodiments, the graphical interface 1100 illustrates the TV show “Shitts Creek” is downloaded on Carl's iPad 1108 and is available for playback on Alice's phone. Continuing with this example, in some embodiments, the graphical interface 1100 illustrates that the TV show “Scandal” was divided for storage amongst two of the four devices 1110 (e.g., two episodes are downloaded on Bob's iPhone and eight episodes are downloaded on Carl's iPad). In some embodiments, the two episodes downloaded on Bob's phone are not available for playback on Alice's phone but are available of playback on Bob's phone. In some embodiments, Alice's phone is configured, based on the configuration data associated with Alice's phone (e.g., the DRM information within the configuration data), to play the eight episodes of the show “Scandal” downloaded on Carl's iPad 1110. Further, all eight episodes of the TV show “Homeland” are downloaded on Tom's phone, but Alice's phone detects that Tom's Phone is not currently available for access 1112 (e.g., Tom's phone is not in the proximity of Alice's phone). In some embodiments, the graphical interface 1100 illustrates two episodes of “Brothers and Sisters” are downloaded to Alice's phone 1114 and are not available for playback at Alice's phone. In some embodiments, even though the two episodes of “Brothers and Sisters” are downloaded to Alice's phone 1114, Alice's phone is not configured, based on the configuration data associated with Alice's phone, with playback permissions. In some embodiments, for example, Alice's phone may be configured, based on the configuration data, to transfer the two episodes of “Brothers and Sisters” downloaded to Alice's phone 1114 to other devices within the shared storage pool (e.g., Carl's iPad, Bob's phone, and/or Tom's phone) which may be configured, based on the associated configuration data, to play the two episodes of “Brothers and Sisters” downloaded on Alice's phone 111. In some embodiments, the graphical interface 1100 illustrates content that is crossed out, text on the content item indicating that the content is not downloaded, is faded, and/or is visually distinguishable from the content that is unavailable 1104 and 1116 because it was not downloaded to any devices amongst the four devices.

FIG. 12 is an illustrative example of graphical interface 1200 to manage content storage and transfer across multiple devices and user profiles associated with a shared streaming account, in accordance with some embodiments of this disclosure.

In some embodiments, one of the devices, for example, Alice's device 1202, logged into a streaming service account 1218 generates for output a graphical interface 1200 that includes options 1214 and 1216 (e.g., toggles) for the device to receive a user interface input to select roles for each of the devices associated with the streaming service account 1218.

As illustrated in this example, the graphical interface 1200 at Alice's device 1202 displays options associated with the content “twilight” 1204. In this example, there are two devices, device 1206 (e.g., device 110 of FIG. 1) and device 1208 (e.g., device 102 of FIG. 1), that are currently available associated with the streaming service account 1218 (e.g., streaming service account 1218 of FIG. 1). Further, following this example, Alice's device 1202, generates for output options, such as toggles 1214 and 1216, wherein the Alice's device 1202 may receive a user interface input 1214 or 1216 selecting which devices associated with the streaming service account 1218 are to be the playback device 1210 and the storage device 1212. Although only two devices are shown in this illustrative example, device 1206 (e.g., device 110 of FIG. 1) and device 1208 (e.g., device 102 of FIG. 1), it should be understood the two devices are for illustrative purposes only and multiple devices (e.g., five, ten, fifteen, twenty, etc.) may be associated with the streaming service account 1218 (e.g., streaming service account 118 of FIG. 1). In some embodiments, as illustrated in this example, Alice's device 1202, receives a user interface input 1216 selecting device 1206 (e.g., device 110 of FIG. 1) as the storage device, and user interface input 1214 selecting device 1208 (e.g., device 102 of FIG. 1) as the playback device 1210.

In some embodiments, Alice's device 1202 may receive a user interface input 1214 or 1216 switching the roles of the devices associated with the streaming service account 1218. For example, Alice's device 1202 (e.g., Alice's laptop) may initially receive a user interface input 1214 selecting device 1208 (e.g., device 102 of FIG. 1) as the playback device 1210 in which the streaming service server (e.g., server 108 of FIG. 1) prioritizes device 1208 (e.g., device 102 of FIG. 1) for downloading all relevant content. In some embodiments, Alice's device 1202 (e.g., Alice's laptop) may later receive a user interface input switching the roles of the devices, such that device 1208 (e.g., device 102 of FIG. 1) is now the storage device, and device 1206 (e.g., device 110 of FIG. 1) is now the playback device, such as for watching a movie on a long flight.

In some embodiments, in response to this switch of device roles, the streaming service server (e.g., server 108 of FIG. 1) now priorities device 1206 (e.g., device 110 of FIG. 1) and transfers all relevant content to the new playback device (e.g., device 110 of FIG. 1). In some embodiments, the streaming service server (e.g., server 108 of FIG. 1) may update the graphical interface (e.g., graphical interface 1200) reflecting device 1206 (e.g., device 110 of FIG. 1) as the new playback device, ensuring that any actions or controls related to media management are directed towards device 1206 (e.g., device 110 of FIG. 1) rather than device 1208 (e.g., device 102 of FIG. 1). In some embodiments, the streaming service server (e.g., server 108 of FIG. 1) automatically updates the graphical interface (e.g., graphical interface 1200) ensuring that the settings are consistent amongst the devices associated with the streaming service account (e.g., streaming service account 1218) without the need for each of the devices to be manually adjusted to reflect the changes.

In some embodiments, the streaming service server (e.g., server 108 of FIG. 1) may automatically adjust the roles of the devices based on real-time activity detected as each of the devices associated with the streaming service account 1218. In some embodiments, the streaming service server may recognize that a device designated as a storage cache device may become the playback device under certain conditions. In some embodiments, the detection may be based on various indicators such as increased activity at a device, device location, application usage patterns, or user interface input indicating which devices are to act as playback and storage devices. For example, the streaming service server may detect from all of the devices associated with a streaming service account, an increased activity at a device currently designated as a storage device compared to a device currently assigned as the playback device over a threshold period of time. In some embodiments, in response to this detected increased activity at the device currently designated as a storage y device, the streaming service server may automatically reassign the roles of the devices such that the storage device is now the playback device. In some embodiments, the streaming service server may update the graphical interface (e.g., 1200) reflecting the new playback device, ensuring that any actions or controls related to media management are directed towards the new playback device rather than the previously assigned playback device. In some embodiments, the streaming service server adjusts the roles of the devices with the streaming service account in real time. In some embodiments, the ability of the streaming service server to proactively cache content at the devices based on their roles (e.g., playback and storage devices) reduces network congestion and bandwidth constraints, ensuring that the devices have immediate access to the content.

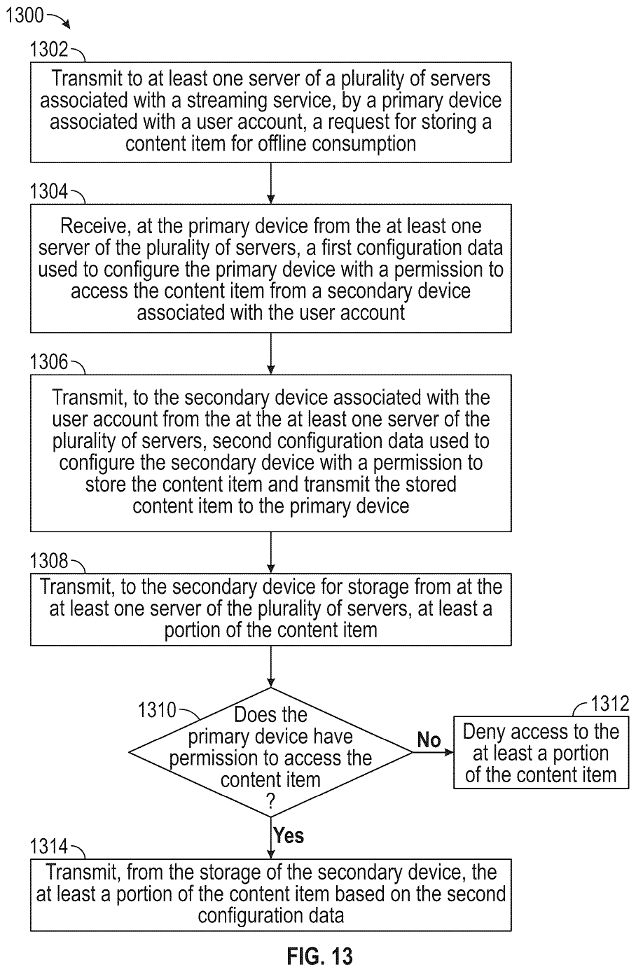

FIG. 13 is a flowchart of a detailed illustrative process for dynamically managing content across multiple devices and user profiles associated with a shared streaming account, in accordance with some embodiments of this disclosure. In various embodiments, the individual steps of process 1300 may be implemented by one or more components of the devices, methods and systems of FIGS. 1-12 and may be performed in combination with any of the other processes and aspects described herein. Although the present disclosure may describe certain steps of process 1300 (and of other processes described herein) as being implemented by certain components of the devices, methods, and systems of FIGS. 1-12, this is for purposes of illustration only, and it should be understood that other components of the devices, methods, and systems of FIGS. 1-12 may implement those steps instead.

At 1302, input/output (“I/O”) circuitry (e.g., of I/O path 812 of FIG. 8 and/or of I/O path 902 of FIG. 9) may transmit, by a primary device associated with a user account (e.g., primary device 102 of FIG. 1), to at least one server of a plurality of servers associated with a streaming service, a request for storing a content item (e.g., content item 114 of FIG. 1) for offline storage. For example, a primary device may receive a user interface input (e.g., user interface input 112 of FIG. 1) selecting to download the movie “twilight” to Bob's device for offline consumption.

At 1304, I/O circuitry may receive, at the primary device from the at least one server of the plurality of servers, a first configuration data used to configure the primary device with a permission to access the content item from a secondary device associated with the user account. For example, the configuration data (e.g., configuration data 104 of FIG. 1) received at the primary device may include permissions, such as retrieval permissions, that permit the primary device to access the content from the secondary, cache device(s). In some embodiments, the configuration data received at the I/O at the primary device, may also include details such as the device's ID, the type of connection to be used with the secondary, cache device(s) (e.g., Wi-Fi Direct), and DRM information to ensure that only the primary device has access to the content. In some embodiments, the configuration data received at the I/O circuitry at the primary device may also include a small portion of the content item such as a thumbnail, a first N number of bytes, or the first N number of segment, allowing for immediate playback while the remaining content is accessed from the secondary, cache device.

At 1306, I/O circuitry (e.g., of I/O path 812 of FIG. 8 and/or of I/O path 902 of FIG. 9) may transmit, to the secondary device associated with the user account (e.g., secondary device 110 of FIG. 1) from the at the at least one server of the plurality of servers, second configuration data (e.g., configuration data 106 of FIG. 1) used to configure the secondary device with a permission to store the content item and transmit the stored content item to the primary device. For example, as depicted in FIG. 1, I/O of the at least one server of the plurality of servers 108, transmits to Bob's device 110 (e.g., the secondary device) configuration data 106 (e.g., second configuration data) used to configure Bob's device with permissions to store the content item (e.g., based on the devices role as cache device), to transfer the content item to Alice's device 104 (e.g., the primary device), and to deny streaming of the content item at Bob's device 110 (e.g., the secondary device). In some embodiments, the configuration data transmitted to the secondary device may also specify the devices role (e.g., secondary, cache device), time based access controls (e.g., permit file transfer to the primary device until a specified date), and storage limitations (e.g., max cache size is 10 GB and the current usage is 3 GB).

At 1308, I/O circuitry transmits to the secondary device for storage from at the at least one server of the plurality of servers, at least a portion of the content item. For example, the streaming service server (e.g., streaming service server 304 of FIG. 3) may assess the available storage capacity at the primary device (e.g., primary device 302 of FIG. 3) and determine that the primary devices does not have enough available storage to store all portions of the content item. The streaming service server (e.g., streaming service server 304 of FIG. 3) may then assess the storage capacity on the selected secondary, cache device(s) (e.g., secondary, cache device(s) of FIG. 3) and make a determination of how to store the content item across the secondary, cache devise in the most efficient manner.

At 1310, control circuitry (e.g., control 811 of FIG. 8 and/or control circuitry 904 of FIG. 9) may determine based on the I/O circuitry receiving a user interface input to play the content item at the primary device whether the primary device has permission to access the content item from the secondary, cache device, based on the first configuration data (e.g., the configuration data associated with the primary device). For example, I/O circuitry of the primary device may receive a user interface input (e.g., user interface input 124 of FIG. 1) requesting to play the movie “twilight”. Control circuitry may, based on the configuration data associated with the primary device (e.g., configuration data 104 of FIG. 1) determine the primary device's (e.g., primary device 102 of FIG. 1) permissions associated with the content item stored at the secondary, cache devices (e.g., secondary, cache device 110 of FIG. 1). does have “streaming” permissions associated with the device.

At 1312, based on the control circuitry determining that the primary device does not have permissions, based on the first configuration data, to access the content item, the control circuitry denies access to the at least a portion of the content item stored at the secondary, cache device. For instance, I/O circuitry may transmit from the at least one server of the plurality of servers, to the primary device, a notification indicating that the primary device does not have access to the requested content item.

At 1314, based on the control circuitry determining that the primary device does have permissions, based on the first configuration data, to access the content item, the I/O circuitry transmits, from the storage of the secondary device, the at least a portion of the content item, based on the second configuration data.

1. A method comprising:
transmitting to at least one server of a plurality of servers associated with a streaming service, by a primary device associated with a user account, a request for storing a content item for offline consumption;
receiving, at the primary device from the at least one server of the plurality of servers, a first configuration data used to configure the primary device with a permission to access the content item from a secondary device associated with the user account, wherein the at least one server of the plurality of servers is configured to:
transmit, to the secondary device associated with the user account, second configuration data used to configure the secondary device with a permission to store the content item and transmit the stored content item to the primary device;
transmit for storage at the secondary device at least a portion of the content item; and
based on a user interface input to play the content item at the primary device:
accessing, based on the first configuration data, the at least a portion of the content item from the storage of the secondary device, wherein the secondary device transmits the at least a portion of the content item based on the second configuration data.

2. The method of claim 1, wherein the first configuration data further comprises an initial portion of the content item and wherein the at least one server of the plurality of servers is configured to permit the primary device to play the initial portion of the content item before receiving the at least a portion of the content item from the secondary device.

3. The method of claim 1, wherein the user account comprises a first user profile and a second user profile and wherein the first user profile is associated with the primary device and the second user profile is associated with the secondary device, the method further comprising:
receiving, at the primary device, a user interface input for selecting at least one of: (a) the second user profile associated with the secondary device; or (b) the secondary device to store the content item; and
transmitting, from the at least one server of the plurality of servers, a notification to the secondary device prompting approval to store the requested content item at the secondary device.

4. The method of claim 1, wherein the transmitting for storage at the secondary device the at least a portion of the content item comprises transmitting the at least a portion of the content item in encrypted format; and
wherein the configuring the primary device based on the first configuration data comprises providing the primary device with a key for decryption of the at least a portion of the content item in the encrypted format.

5. The method of claim 4, wherein the configuring the secondary device based on the second configuration data comprises restricting the secondary device from storing the key for decryption of the at least a portion of the content item in the encrypted format.

6. The method of claim 4, wherein the configuring the secondary device based on the second configuration data comprises providing the secondary device with the key for decryption of the content item in the encrypted format based on a request from the secondary device to access the content item.

7. The method of claim 1, wherein the primary device accesses the content item from the storage of the secondary device, the primary device is further configured to:
remove, from the secondary device based on the second configuration data, the content item from the storage of the secondary device.

8. The method of claim 1, wherein the second configuration data further comprises a restriction to access the at least a portion of the stored content item from the storage of the secondary device; and
wherein transmitting for storage at the secondary device at least a portion of the content item further comprises:
based on a user interface input to play the content item at the secondary device:
denying access, based on the second configuration data, to the at least a portion of the content item from the storage of the secondary device.

9. The method of claim 1, wherein the first configuration data or the second configuration data further comprises a time restriction for permitting the transmission of the stored at least a portion of the content item from the secondary device to the primary device; and
wherein based on the user interface input to play the content item at the primary device:
determining, based on the second configuration data, whether the user interface input to play the content item at the primary device was received within the time restriction for permitting the transmission of the at least a portion of the content item from the storage of the secondary device to the primary device.

10. The method of claim 1, wherein the first configuration data further comprises a connection type between the primary device and the secondary device; and
the method further comprising:
based on the user interface input to play the content item at the primary device:
determining, based on the first configuration data, whether the primary device and the secondary device are connected via the connection type; and
based on determining the primary device and the secondary device are connected via the connection type, transmitting, from the storage of the secondary device, the at least a portion of the content item, to the primary device.

11. The method of claim 1, wherein the first configuration data further comprises digital rights management information, and wherein based on the user interface input to play the content item at the primary device further comprises:
determining, based on the digital rights management information in the first configuration data, whether the primary device has access rights to the at least a portion of the content item from the storage of the secondary device; and
based on determining the primary device has access rights to the at least a portion of the content item from the storage of the secondary device, accessing, based on the first configuration data, at least a portion of the content item from the storage of the secondary device, wherein the secondary device transmits the content item based on the second configuration data.

12. The method of claim 1, wherein transmitting to at least one server of the plurality of servers associated with the streaming service, by the primary device associated with the user account, the request for storing the content item for offline consumption, wherein the at least one server of plurality of servers is further configured to:
determine, an available storage capacity at the primary device and an available storage capacity at the secondary device;
select, based on the available storage capacity of the primary device and the available storage capacity of the secondary device, a particular bitrate of the content item for storing for offline consumption; and
transmit for storage at the secondary device the at least a portion of the content item based on the selected particular bitrate.

13. The method of claim 1, wherein the at least one server of the plurality of servers is configured to transmit the first configuration data and the second configuration data, further comprises:
transmitting, to the primary device or the secondary device a playback manifest file associated with the content item wherein the playback manifest file comprises URIs of portions of the content item.

14. The method of claim 1, wherein the transmitting for storage at the secondary device the at least a portion of the content item comprises:
determining, an available storage capacity at the primary device;
in response to determining the primary device has insufficient storage capacity to store all portions of the content item, determining an available storage capacity at the secondary device; and
in response to determining the secondary device has available storage capacity to store at least a portion of the content item, transmitting for storage at the secondary device, the at least a portion of the content item.

15. A system comprising:
control circuitry configured to:
transmit to at least one server of a plurality of servers associated with a streaming service, by a primary device associated with a user account, a request for storing a content item for offline consumption;
input/output circuitry configured to:
receive, at the primary device from the at least one server of the plurality of servers, a first configuration data used to configure the primary device with a permission to access the content item from a secondary device associated with the user account, wherein the control circuitry of the at least one server of the plurality of servers is further configured to:
transmit, to the secondary device associated with the user account, second configuration data used to configure the secondary device with a permission to store the content item and transmit the stored content item to the primary device;
transmit for storage at the secondary device at least a portion of the content item; and
based on a user interface input to play the content item at the primary device:
access, based on the first configuration data, the at least a portion of the content item from the storage of the secondary device, wherein the secondary device transmits the at least a portion of the content item based on the second configuration data.

16. The system of claim 15, wherein the first configuration data further comprises an initial portion of the content item and wherein the at least one server of the plurality of servers is configured to permit the primary device to play the initial portion of the content item before receiving the at least a portion of the content item from the secondary device.

17. The system of claim 15, wherein the user account comprises a first user profile and a second user profile and wherein the first user profile is associated with the primary device and the second user profile is associated with the secondary device, the control circuitry further comprising:
receive, at the primary device, a user interface input for selecting at least one of: (a) the second user profile associated with the secondary device; or (b) the secondary device to store the content item; and
transmit, from the at least one server of the plurality of servers, a notification to the secondary device prompting approval to store the requested content item at the secondary device.

18. The system of claim 15, wherein the transmitting for storage at the secondary device the at least a portion of the content item comprises transmitting the at least a portion of the content item in encrypted format; and
wherein the configuring the primary device based on the first configuration data comprises providing the primary device with a key for decryption of the at least a portion of the content item in the encrypted format.

19. The system of claim 18, wherein the configuring the secondary device based on the second configuration data comprises restricting the secondary device from storing the key for decryption of the at least a portion of the content item in the encrypted format.

20. The system of claim 18, wherein the configuring the secondary device based on the second configuration data comprises providing the secondary device with the key for decryption of the content item in the encrypted format based on a request from the secondary device to access the content item.

21. -70. (canceled)
